(19) United States
(12) Patent Application Publication
(10) Pub. No.: US 2026/0203856 A1
(43) Pub. Date: Jul. 16, 2026

(54) COMMUNICATION SYSTEM, INFORMATION PROCESSING SYSTEM, AND IMAGE DISPLAY METHOD

(71) Applicants: Kyoya SAWADA, Kanagawa (JP); Yuki NAGAHARA, Kanagawa (JP); Kotaro SEKI, Kanagawa (JP); Takeshi HOMMA, Hyogo (JP)

(72) Inventors: Kyoya SAWADA, Kanagawa (JP); Yuki NAGAHARA, Kanagawa (JP); Kotaro SEKI, Kanagawa (JP); Takeshi HOMMA, Hyogo (JP)

(73) Assignee: Ricoh Company, Ltd., Tokyo (JP)

(21) Appl. No.: 19/385,666

(22) Filed: Nov. 11, 2025

(30) Foreign Application Priority Data
Jan. 16, 2025 (JP) 2025-006252

(51) Int. Cl. G06T 3/40; G06T 1/60; G06V 10/25

(52) U.S. Cl. CPC G06T 3/40; G06T 1/60; G06V 10/25

(57) ABSTRACT

A communication system includes an information processing system to cause a plurality of communication terminals to each display shared images, including: a first memory that stores, for each of the shared images, a first frequency in association with identification information of the shared image, the first frequency indicating a frequency that an enlargement operation is performed on a portion of the shared image while a size of a display field for displaying the shared image remains unchanged on each of the plurality of communication terminals; and circuitry that determines a shared image of interest among the shared images, based on the first frequency associated with each of the shared images, and at least one of the plurality of communication terminals displays the shared image of interest in a larger size than a rest of the shared images.

### CROSS-REFERENCE TO RELATED APPLICATIONS

This patent application is based on and claims priority pursuant to 35 U.S.C. § 119 (a) to Japanese Patent Application No. 2025-006252, filed on Jan. 16, 2025, in the Japan Patent Office, the entire disclosure of which is hereby incorporated by reference herein.

### BACKGROUND

### Technical Field

The present disclosure relates to a communication system, an information processing system, and an image display method.

### Related Art

A known communication system transmits at least images and audio from one site to one or more other sites in real time to allow users at remote sites to perform remote communication using the images and audio. A display screen of a communication terminal displays a shared image transmitted from another site. An increase in the number of participants in a conference and an increase in the number of shared images to be displayed on one screen make it difficult to identify which shared image is to be focused on.

### SUMMARY

The present disclosure described herein provides a communication system including a plurality of communication terminals each to display a shared image and an information processing system including a first memory and circuitry. The information processing system transmits, via a network, the shared image displayed at one of the plurality of communication terminals to another of the plurality of communication terminals, to cause the plurality of communication terminals to each display the shared images. The first memory stores, for each of the shared images, a first frequency in association with identification information of the shared image. The first frequency indicates a frequency that an enlargement operation is performed on a portion of the shared image while a size of a display field for displaying the shared image remains unchanged on each of the plurality of communication terminals. The circuitry determines a shared image of interest among the shared images, based on the first frequency associated with each of the shared images. At least one of the plurality of communication terminals displays the shared image of interest in a larger size than a rest of the shared images.

The present disclosure described herein provides an information processing system including circuitry that transmits, via a network, a shared image displayed at one of a plurality of communication terminals to another of the plurality of communication terminals, to cause the plurality of communication terminals to each display the shared images. The information processing system further includes a first memory that stores, for each of the shared images, a first frequency in association with identification information of the shared image, the first frequency indicating a frequency that an enlargement operation is performed on a portion of the shared image while a size of a display field for displaying the shared image remains unchanged on each of the plurality of communication terminals. The circuitry determines a shared image of interest among the one or more shared images, based on the first frequency associated with each of the shared images, and transmits the determined shared image of interest to at least one of the plurality of communication terminals, the shared image of interest being displayed in a larger size than a rest of the shared images.

The present disclosure described herein provides an image display method including: transmitting, via a network, a shared image displayed at one of a plurality of communication terminals to another of the plurality of communication terminals to cause the plurality of communication terminals to each display the shared images; determining a shared image of interest among the shared images, based on a first frequency stored in a first memory in association with each of the shared images, the first memory storing, for each of the shared images, a first frequency in association with identification information of the shared image, the first frequency indicating a frequency that an enlargement operation is performed on a portion of the shared image while a size of a display field for displaying the shared image remains unchanged on each of the plurality of communication terminals; and displaying, on at least one of the communication terminals, the determined shared image of interest in a larger size than a rest of the shared images.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of remote communication using a wide-view image;

FIG. 2 is a diagram illustrating an example schematic configuration of a communication system;

FIG. 3 is a diagram illustrating an example hardware configuration of an image capturing apparatus;

FIG. 4 is a diagram illustrating an example hardware configuration of a communication terminal and an information processing system;

FIGS. 5A, 5B, and 5C are a left side view, a front view, and a plan view of the image capturing apparatus according to an embodiment of the present disclosure, respectively;

FIG. 6 is an illustration of an example of how the image capturing apparatus is used;

FIGS. 7A, 7B, and 7C are diagrams illustrating an example of a hemispherical image (front side) captured by the image capturing apparatus, an example of a hemispherical image (back side) captured by the image capturing apparatus, and an example of an image in equirectangular projection, respectively;

FIG. 8A is an illustration of an example of how the image in equirectangular projection is mapped to a surface of a sphere;

FIG. 8B is a diagram illustrating an example of a spherical image;

FIG. 9 is a diagram illustrating an example of the positions of a virtual camera and a predetermined area in a case where the spherical image is of a three-dimensional sphere;

FIG. 10A is a perspective view of an example of the virtual camera and the predetermined area illustrated in FIG. 9;

FIG. 10B is a diagram illustrating an example of an image of the predetermined area displayed on a display;

FIG. 11 is a diagram illustrating an example of the relationship between predetermined-area information and the image of the predetermined area;

FIG. 12 is a diagram illustrating an example of a point in a three-dimensional Euclidean space defined in spherical coordinates;

FIG. 13 is a diagram illustrating an example functional configuration of the communication system;

FIGS. 14A and 14B are tables illustrating examples of image management information stored in an image management information storage unit;

FIG. 15 is a table illustrating an example of virtual room information stored in a virtual room information storage unit;

FIG. 16A is a diagram illustrating an example of a room entry screen;

FIG. 16B is a diagram illustrating an example of an image viewing screen displayed on the communication terminal in response to a user entering a virtual room;

FIG. 17 is a sequence diagram illustrating an example of a process in which the user (or the communication terminal) enters the virtual room;

FIG. 18 is a diagram illustrating an example of a virtual room association screen for associating an image capturing apparatus with a virtual room;

FIG. 19 is a diagram illustrating another example of the virtual room association screen;

FIG. 20 is a diagram illustrating another example of the virtual room association screen;

FIGS. 21A and 21B are diagrams illustrating examples of a wide-view image transmission start/stop dialog displayed on the communication terminal;

FIG. 22 is a sequence diagram illustrating an example of a procedure in which the user registers the image capturing apparatus in a virtual room;

FIG. 23 is a sequence diagram illustrating an example of a process for sharing a wide-view image;

FIG. 24 is a diagram illustrating an example of a video conference screen displayed on a communication terminal by a user;

FIGS. 25A and 25B are diagrams illustrating how a shared image changes in response to the user performing an enlargement operation on a portion of the shared image;

FIGS. 26A and 26B are diagrams illustrating how a layout changes in response to the user performing an enlargement operation on one shared image field.

FIG. 27 is a diagram illustrating an example of enlargement operation information for partial enlargement;

FIG. 28 is an illustration of an example of evaluation information stored in an evaluation information storage unit;

FIG. 29 is an illustration of an example of enlargement operation information stored in an enlargement operation information storage unit;

FIGS. 30A, 30B, and 30C are diagrams illustrating examples of video conference screens displayed on communication terminals operated by three users;

FIG. 31 is a diagram illustrating an example of a video conference screen displayed on the communication terminal in response to the user pressing a layout-of-interest button;

FIG. 32 is a sequence diagram illustrating an example of a process in which a user displays a region of interest;

FIG. 33 is a diagram illustrating an example of remote communication using the communication system in telemedicine; and

FIG. 34 is a diagram illustrating an example of a virtual room association screen for associating an image capturing apparatus with a virtual room for telemedicine.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

There is a technique for calculating a degree of interest by aggregating the handling states of shared data by other users. For example, the degree of interest is calculated based on a window size of an image displayed by each user, and a screen is displayed on a terminal of a newly participating user in a predetermined layout based on the degree of interest.

In the technique of the related art, however, it is difficult to determine a shared image to be a shared image of interest unless the shared image is displayed in a large-sized field. For example, when a large-sized window and a small-sized window are being displayed, the small-sized window may attract more attention of many users in some cases. In this case, a shared image displayed in the large-sized field may be determined to be a shared image of interest even if users wish to view a shared image that attracts attention. The determined shared image of interest may be inappropriate.

Accordingly, the present disclosure provides a technique for appropriately determining a shared image of interest.

An information processing system and an image display method performed by the information processing system will be described hereinafter as an example of an embodiment of the present disclosure.

### Example of Remote Communication

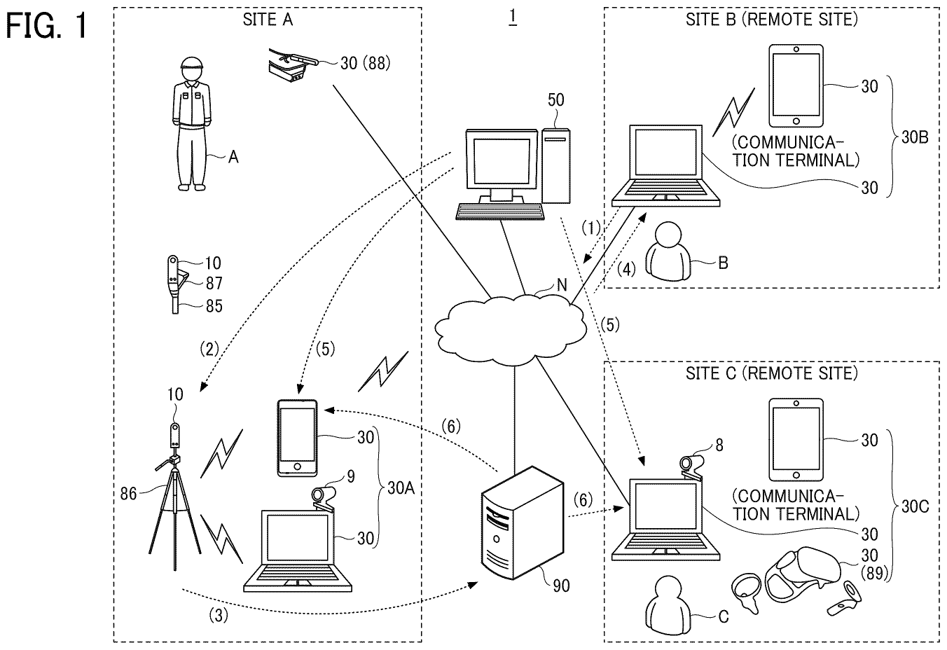

FIG. 1 is a diagram illustrating an example of remote communication using a wide-view image. In FIG. 1, communication takes place across three sites, namely, a site A, a site B, and a site C, via an information processing system 50. Three sites are merely an example, and communication may be performed across two sites or four or more sites. Remote communication refers to communication that takes place between individuals who are located in physically distant locations by using information technology (IT) tools through images and/or audio.

In one example, the site A is a construction site. The sites B and C are any sites across which a wide-view image can be communicated. In one example, the sites B and C are offices. An image capturing apparatus 10 is placed at the site A. In one example, the image capturing apparatus 10 captures a wide-angle image called a spherical image and an image with a wide angle of view ranging from, for example, 180 degrees to 360 degrees in the horizontal direction. Such an image with a wide angle of view is hereinafter simply referred to as a “wide-view image”. Communication terminals 30A to 30C for viewing a wide-view image are placed at the sites A to C, respectively. Any communication terminal or communication terminals among the communication terminals 30A to 30C are hereinafter referred to as a “communication terminal 30” or “communication terminals 30”.

In the construction site, workers are involved in various constructions at various places. A user A at the site A, a user B at the site B, and a user C at the site C monitor any construction and/or work of interest by changing a point of view as appropriate for a wide-view image that is a captured image of the entire construction site. The term “point of view” refers to the center position or range of the entire wide-view image. The center position or range of the entire wide-view image is to be displayed on displays or other means of the communication terminals 30A and 30C.

In one example, the image capturing apparatus 10 is attached to a tripod 86. In another example, the image capturing apparatus 10 is attached to an arm 85 through a gimbal 87. A relay device is installed at the construction site. In FIG. 1, the communication terminal 30A also functions as the relay device. The communication terminal 30A receives a wide-view image from the image capturing apparatus 10 via a wire or wirelessly and transmits the received wide-view image to the information processing system 50. The communication terminal 30A may also function as a terminal for viewing the wide-view image. In one example, a camera 9 connected to (or incorporated in) the communication terminal 30A captures an image having a normal angle of view (or a spherical image), and the captured image is transmitted to the information processing system 50. In another example, smart glasses 88 worn by the user A capture an image having a normal angle of view (or a spherical image), and the captured image is transmitted to the information processing system 50. The user A may be a worker. The smart glasses 88 are an information terminal having a display on which information acquired via the Internet is displayed with a field of view maintained. The smart glasses 88 may be placed at any site.

The communication terminal 30B, such as a personal computer (PC) or a smartphone, is placed at the site B. The communication terminal 30B is any device for communicating with the information processing system 50 via a communication network N. Other examples of the communication terminal 30B include display devices such as a tablet terminal, a personal digital assistant (PDA), an electronic whiteboard, and a projector. A camera may be incorporated in or connected to the communication terminal 30B.

The communication terminal 30C, such as a PC, a smartphone, or virtual reality (VR) goggles 89, is placed at the site C. In FIG. 1, a camera 8 is incorporated in or connected to the communication terminal 30C. The VR goggles 89 are an information terminal for displaying a computer-based artificial world or a spherical image in accordance with the direction of movement of the neck or the body of the user wearing the VR goggles 89. The camera 8 may be for a wide angle of view or a normal angle of view. The communication terminal 30C is any device for communicating with the information processing system 50 via the communication network N. Other examples of the communication terminal 30C include display devices such as a tablet terminal, a PDA, an electronic whiteboard, and a projector. The VR goggles 89 may be placed in any site.

In the present embodiment, the image capturing apparatus 10 and the communication terminals 30 are managed using a communication group called a virtual room. The image capturing apparatus 10 is associated with the virtual room. Each of the communication terminals 30 (the user who operates each of the communication terminals 30) enters the virtual room to receive a wide-view image transmitted from the image capturing apparatus 10. As a result, the user can view the wide-view image. The smart glasses 88 and the VR goggles 89 can also be associated with the virtual room. The cameras 8 and 9 enter the virtual room together with the communication terminals 30.

The users A to C at the sites A to C can each change the point of view for the wide-view image, as desired. Thus, the users A to C may view the wide-view image in real time from different points of view. It may be difficult for the users A to C to mutually understand each other. In the present embodiment, accordingly, for example, the point of view of the communication terminal 30A at the site A is transmitted to the communication terminals 30B and 30C at the other sites, namely, the sites B and C. An overview of the sharing of a point of view will be described. In the following description, in one example, the point of view of the user B at the site B is shared by the users A and C at the sites A and C.
(1) The communication terminals 30A to 30C share a wide-view image captured by the image capturing apparatus 10. In response to the user B making a request to capture a wide-view image while viewing the wide-view image from any point of view on the communication terminal 30B, the communication terminal 30B transmits point-of-view information and the request to the information processing system 50.
(2) In response to the request, the information processing system 50 designates point-of-view information and transmits an image capturing request to the image capturing apparatus 10 to capture an image (either a still image or a moving image).
(3) The image capturing apparatus 10 captures a wide-view image in response to the image capturing request, and stores the wide-view image and the point-of-view information in a uniform resource locator (URL) transmitted from the information processing system 50. The URL is an example of storage destination information. In FIG. 1, the image capturing apparatus 10 stores the wide-view image and the point-of-view information in a storage 90. The wide-view image stored in the storage 90 can be downloaded and displayed by any communication terminal 30.
(4) The information processing system 50 transmits the URL to the communication terminal 30B.
(5) The information processing system 50 further transmits the URL to the communication terminals 30A and 30C, which are in the same virtual room as that associated with the image capturing apparatus 10 and the communication terminal 30B, automatically or in response to a request from the user B.
(6) The communication terminals 30A and 30C connect to the URL and receive the point-of-view information and the wide-view image. Each of the communication terminals 30A and 30C sets and displays a point of view identified by the point-of-view information for the wide-view image such that the point of view matches the center of an image field. In one example, the point of view is not made to completely match the center of the image field. In another example, the point of view may be set and displayed so as to be included in a range near the center of the image field.

The same applies when the point of view of the user A at the site A is shared by the users B and C at the sites B and C and when the point of view of the user C at the site Cis shared by the users A and B at the sites A and B.

As described above, in a communication system 1 according to the present embodiment, even in a case where a wide-view image is distributed, point-of-view information is shared at the respective sites. This facilitates understanding among users at the respective sites.

In (3), the image capturing apparatus 10 may transmit the wide-view image itself to the information processing system 50. In (4), the information processing system 50 may transmit the wide-view image to the communication terminals 30A to 30C.

In the example illustrated in FIG. 1, the image capturing apparatus 10 is placed at a construction site. The present embodiment is also applicable to VR education, event distribution, remote customer services, telemedicine services, and other suitable situations. In VR education, the image capturing apparatus 10 is placed at a site such as a study room or a laboratory. Students can view a blackboard, an instrument, a sample, an experimental result, or the like from remote sites while changing the points of view as appropriate. In event distribution, the image capturing apparatus 10 is placed in a venue of an event to be held on-site. Event participants such as an audience can view the details in the venue online from remote sites while changing the points of view as appropriate. The details in the venue include images of event performers, event participants, and event presenters, images of objects involved in the event, such as products and exhibits, images of materials involved in the event, and images of the venue. The event may be held indoors or outdoors, and examples of the venue of the event include venues such as sports stadiums, concert halls, and theaters. In remote customer services, for example, in customer services for a travel agency, the image capturing apparatus 10 is placed at each of travel destination sites. A customer can plan their itinerary from a remote site while changing the point of view as appropriate. In telemedicine services, in one example, the image capturing apparatus 10 is placed in a medical setting such as an operating room. Medical people such as doctors, medical students, and persons related to medical instruments can view the performance of a doctor(s) and a nurse(s) during on-site medical treatment, the arrangement of medical instruments, the state of a patient, vitals, and the like from remote sites while changing the points of view as appropriate.

The site at which an image is captured is not limited to any of the sites described above. An image may be captured in any space that a user (or viewer) at a viewing site desires to remotely grasp. Examples of such a space include a school, a factory, a warehouse, a building site, a server room, and a store.

### Terminology

The term “tenant” refers to an entity such as a company or an organization that has a contract with a service provider to receive an image distribution service. In the present embodiment, the service provider is the information processing system 50. In one example, a user belongs to the tenant. In another example, a user may personally subscribe to the service. A user, an image capturing apparatus, a virtual room, and the like are registered in a tenant.

The term “site” refers to a location where activity takes place. In the present embodiment, a conference room is used as an example of a site. The conference room is a room to be used mainly for a conference. A conference is an event where people gather to discuss something and is also referred to as a meeting, a session, a gathering, an assembly, or the like.

The term “device” refers to an apparatus different from the communication terminal 30 for general purposes such as a PC or a smartphone. In one example, the device is an image capturing apparatus or an apparatus for viewing a wide-view image. In the present embodiment, examples of the device include the image capturing apparatus 10, the smart glasses 88, and the VR goggles 89.

The term “point-of-view information” refers to parameter information that specifies which predetermined area in a wide-view image to be displayed on the display is to be displayed on the display. In the present embodiment, in one example, a radius vector, a polar angle, and an azimuth angle of the center of the wide-view image to be displayed on the display are described as examples of the point-of-view information. In another example, the point-of-view information may be specified by other parameter information such as the coordinates of diagonal vertices.

The term “wide-view image” refers to an image having a wide viewing angle and captured in a wide imaging range. The term “wide-view image” is used to include a 360-degree image that is a captured image of an entire 360-degree view. The 360-degree image is also referred to as a spherical image, an omnidirectional image, or an “all-around” image.

The term “remote communication” refers to communication that takes place between individuals who are located in physically distant locations by using IT tools through images and/or audio. Communication includes, for example, but is not limited to, serving a customer, a conference, a meeting, a gathering, an assembly, a study session, a class, a seminar, and a presentation. The remote communication is not necessarily bidirectional communication. Thus, the virtual room may be referred to as a virtual conference room.

An image having a normal angle of view is not a wide-view image. In the present embodiment, such an image is referred to as a non-wide-view image, that is, a planar image.

The term “communication group” refers to a group of users who share a wide-view image, that is, a group of users to whom a wide-view image is to be distributed. The communication group will be described using the term “virtual room” in the sense that in a typical space, the users in the same room can share a wide-view image. The term “virtual” means being implemented by information processing via a network.

The term “image” refers to a representation of an event visually fixed on a medium. The term “video” refers to an image displayed on a display device.

The term “shared image” refers to an image to be displayed on communication terminals 30 when the image is displayed on a communication terminal 30 and is transmitted to and displayed on another communication terminal 30.

The term “shared image of interest” refers to a shared image determined by a predetermined process and estimated to attract attention when a plurality of shared images are present. In other words, the information processing system 50 allows the communication terminal 30 to display, as a shared image that is to be of interest, a shared image estimated to attract attention.

The term “frequency” refers to the number of times or instances an enlargement operation is performed on a shared image. The enlargement operation includes partial enlargement and full enlargement, and the frequency of each enlargement may be recorded.

### Example Configuration of Communication System

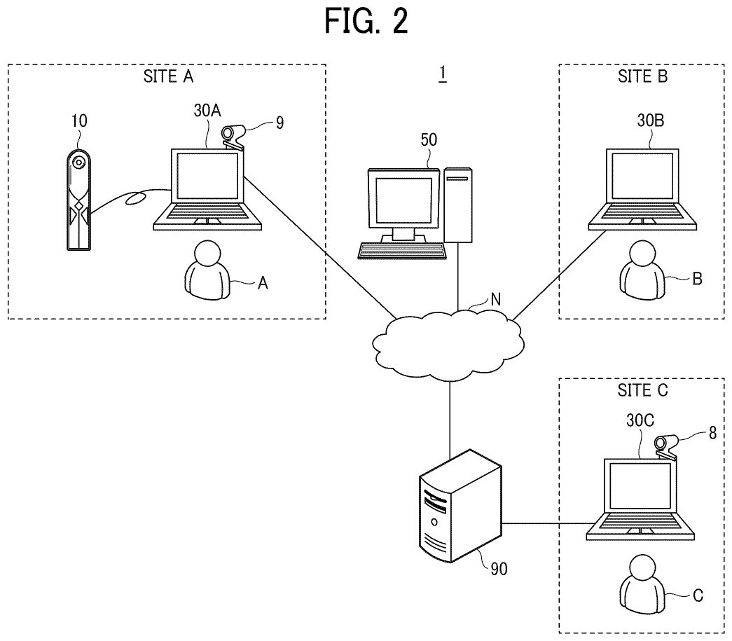

FIG. 2 is a diagram illustrating an example schematic configuration of the communication system 1. The communication system 1 is a system for transmitting and receiving a wide-view image captured by the image capturing apparatus 10 or an image having a normal angle of view bidirectionally among a plurality of sites. In the communication system 1, an image distributed from one of the sites is displayed at the other sites and is viewable to users at the other sites. In an example, a spherical image captured by the image capturing apparatus 10 is distributed as the wide-view image. In the communication system 1, for example, a wide-view image captured at a predetermined site is remotely viewable at another site.

In the communication system 1, as illustrated in FIG. 2, the image capturing apparatus 10 and the communication terminal 30A placed at the site A, the information processing system 50, and the communication terminals 30B and 30C placed at a plurality of sites, namely, the sites B and C, respectively, are communicably connected to each other.

In a case where the image capturing apparatus 10 is directly connectable to the communication network N, the communication terminal 30A serving as a relay device (e.g., a router) is not used. In this case, the image capturing apparatus 10 is connected to the communication network N without the intervention of the communication terminal 30A. In a case where the communication terminal 30A is placed at the site A, the communication terminal 30A also functions as a relay device, and the user A can view a wide-view image in a manner similar to that of the communication terminals 30B and 30C. The image capturing apparatus 10 may additionally be placed at a site other than the site A, or a plurality of image capturing apparatuses 10 may be placed at the site A.

Each communication terminal 30 and the information processing system 50 can communicate with each other via the communication network N. The communication network N includes the Internet, a mobile communication network, and a local area network (LAN), for example. The communication network N may include a wired communication network and a wireless communication network. The wireless communication network may be based on a wireless communication standard such as third generation (3G), fourth generation (4G), fifth generation (5G), Wireless Fidelity (Wi-Fi®), Worldwide Interoperability for Microwave Access (WiMAX), or Long Term Evolution (LTE).

The image capturing apparatus 10 is a special digital camera configured to capture an image of an object and/or surroundings such as scenery to obtain two hemispherical images, from which a spherical image is generated, as described below. The wide-view image obtained by the image capturing apparatus 10 may be a moving image or a still image, or may include both a moving image and a still image. Further, the captured image may be a video including an image and audio.

The communication terminal 30 is a computer such as a PC to be operated by a user at each site. The communication terminal 30 displays an image captured at the site where the communication terminal 30 is placed, and a wide-view image (still image and/or moving image) and an image having a normal angle of view, which are distributed from other sites. For example, the communication terminal 30 acquires a wide-view image, which is captured by the image capturing apparatus 10, via the communication network N. The communication terminal 30 has installed therein software for executing image processing, such as Open Graphics Library for Embedded Systems (OpenGL ES), and can display an image based on point-of-view information that specifies a partial area in the wide-view image. OpenGL ES is an example of software for executing image processing. Any other software may be used. In an example, the communication terminal 30 does not have installed therein software for executing image processing, and executes image processing by using software received from the outside or receives a result of image processing executed by external software to display an image. That is, the communication terminal 30 can display a predetermined area, which is a portion of the wide-view image.

The communication terminal 30 can change the point of view for the display range of the wide-view image, as desired, in response to the user's operation. The communication terminal 30 shifts the virtual point of view in response to a user operation input (such as key input, dragging, or scrolling) on a touch panel, a direction button, a mouse, a keyboard, a touch pad, or the like to change and display a visual field range (predetermined area) based on point-of-view information corresponding to the shifted point of view. In an example, the communication terminal 30 is a communication terminal to be worn by the user, such as VR goggles. In response to a change in the movement of the user wearing the communication terminal 30, position information of the communication terminal 30 is changed. In response to detection of the change in the position information, the virtual point of view is shifted in accordance with the detected position information to change a visual field range (predetermined area), based on point-of-view information corresponding to the shifted point of view, and the changed visual field range (predetermined area) is displayed.

The communication terminal 30A acquires a wide-view image from the image capturing apparatus 10 via a wired cable such as a Universal Serial Bus (USB) cable and distributes the acquired wide-view image to the communication terminal 30 at another site via the information processing system 50. The connection between the image capturing apparatus 10 and the communication terminal 30A may be either a wired connection using a wired cable or a wireless connection using short-range wireless communication, for example. A plurality of communication terminals 30A may be placed at the site A.

In an example, the user A at the site A wears the smart glasses 88, and the smart glasses 88 are connected to the communication network N. In this case, an image captured by the smart glasses 88 may be transmitted to the information processing system 50 via the communication network N, and the information processing system 50 may distribute the image to the communication terminal 30 at each site.

The communication terminal 30B is placed at the site B where the user B is located, and the communication terminal 30C is placed at the site C where the user C is located. A plurality of communication terminals 30B may be placed at the site B, and a plurality of communication terminals 30C may be placed at the site C. The users B and C may carry the communication terminals 30B and 30C, respectively.

Each of the communication terminals 30A to 30C at the sites A to C may be internally or externally provided with the camera. Each of the communication terminals 30A to 30C may distribute an image of the corresponding one of the sites A to C, which is captured by the camera 8 or 9 thereof, to the other sites. Any device may be placed at each of the sites A to C.

The arrangement of the terminals and apparatuses (i.e., the communication terminals 30 and the image capturing apparatus 10) and the users A to C illustrated in FIG. 2 is an example. Any other arrangement may be used. Examples of the communication terminal 30 are not limited to a PC, but include a tablet terminal, a smartphone, a wearable terminal, a projector, an interactive white board (IWB), and a telepresence robot. The IWB is an electronic whiteboard with mutual communication capability. The communication terminal 30 is any computer on which a web browser or an application dedicated to an image distribution service operates.

In an example, the image capturing apparatus 10 includes a display and displays an image distributed from another site on the display.

The information processing system 50 includes one or more information processing apparatuses. The information processing system 50 manages and controls communication among the image capturing apparatus 10 and the communication terminals 30 at the respective sites and manages a wide-view image to be transmitted and received. The information processing system 50 provides a platform on which a function of providing an image distribution service for distributing a wide-view image is available. The platform may be made available to a person, a company, or any other service provider that desires to provide an image distribution service, under contract. A service provider that provides an image distribution service to a user by using a platform is hereinafter referred to as a platform contractor to distinguish the service provider from a tenant who receives the image distribution service.

The information processing system 50 may make an application programming interface (API) public as a platform, and the platform contractor may use the API to provide various image distribution services. The platform contractor mainly develops software such as an application for calling the API or the screen to be displayed on the communication terminal 30. That is, the functions to be provided by the API, such as image distribution, are not developed from scratch.

The information processing system 50 may be implemented by a single computer or a plurality of computers such that the components (functions or means) of the information processing system 50 are divided into and assigned to the plurality of computers as appropriate. All or some of the functions of the information processing system 50 may be implemented by a server computer residing in a cloud environment or a server computer residing in an on-premise environment.

The storage 90 is a storage device separate from the information processing system 50. In one example, the storage 90 is an external storage. The external storage may be a cloud or on-premise storage. In another example, the storage 90 is a storage included in the information processing system 50.

### Example Hardware Configuration

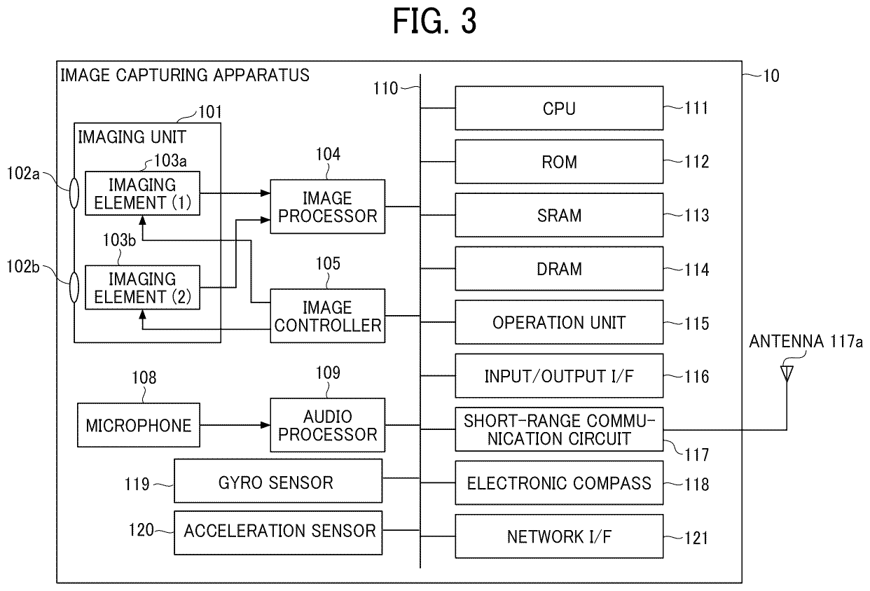

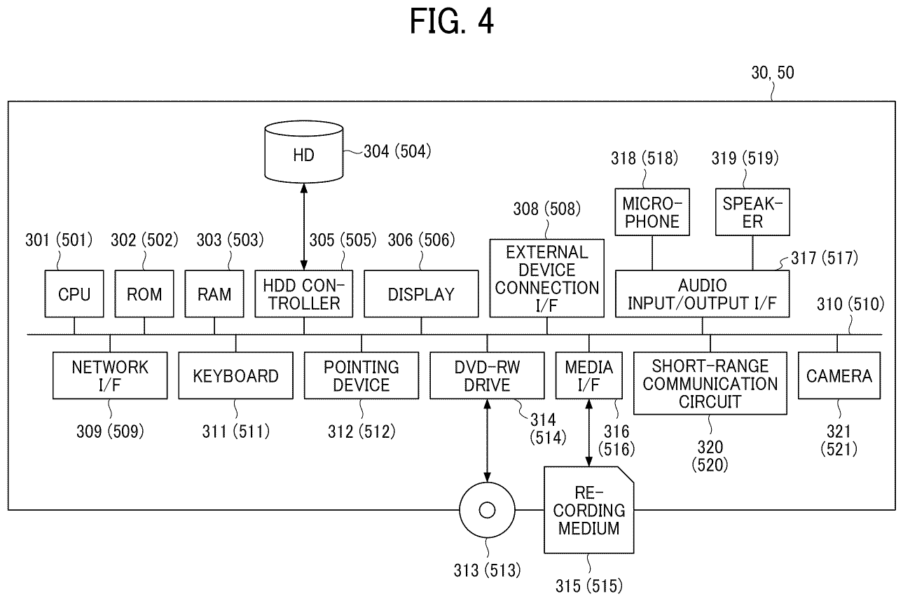

Next, the hardware configuration of each apparatus or terminal included in the communication system 1 according to the present embodiment will be described with reference to FIG. 3 or 4. In the hardware configurations illustrated in FIGS. 3 and 4, a certain hardware element may be added or deleted as appropriate.

### Hardware Configuration of Image Capturing Apparatus

First, the hardware configuration of the image capturing apparatus 10 will be described with reference to FIG. 3. FIG. 3 is a diagram illustrating an example hardware configuration of the image capturing apparatus 10. In the following description, the image capturing apparatus 10 is a spherical (omnidirectional) image capturing apparatus including two imaging elements. In some embodiments, the image capturing apparatus 10 includes any number of imaging elements, provided that the image capturing apparatus 10 includes at least two imaging elements. In one example, the image capturing apparatus 10 is not dedicated to omnidirectional image capturing, and an external omnidirectional image capturing unit is attached to a general-purpose digital camera, a smartphone, or the like to implement functions that are substantially the same as those of the image capturing apparatus 10.

As illustrated in FIG. 3, the image capturing apparatus 10 includes an imaging unit 101, an image processor 104, an imaging controller 105, a microphone 108, an audio processor 109, a central processing unit (CPU) 111, a read only memory (ROM) 112, a static random access memory (SRAM) 113, a dynamic random access memory (DRAM) 114, an operation unit 115, an input/output interface (I/F) 116, a short-range communication circuit 117, an antenna 117a for the short-range communication circuit 117, an electronic compass 118, a gyro sensor 119, an acceleration sensor 120, and a network I/F 121.

The imaging unit 101 includes two wide-angle lenses (so-called fish-eye lenses) 102a and 102b (collectively referred to as a lens 102 unless distinguished), each having an angle of view of greater than or equal to 180 degrees so as to form a hemispherical image. The imaging unit 101 further includes two imaging elements 103a and 103b corresponding to the lenses 102a and 102b respectively. Each of the imaging elements 103a and 103b includes an image sensor such as a complementary metal oxide semiconductor (CMOS) sensor or a charge-coupled device (CCD) sensor, a timing generation circuit, and a group of registers. The image sensor converts an optical image formed by the lens 102a or 102b into an electric signal and outputs image data. The timing generation circuit generates horizontal or vertical synchronization signals, pixel clocks, and the like for the image sensor. In the group of registers, various commands, parameters, and the like for an operation of the imaging element 103a or 103b are set. As a non-limiting example, the imaging unit 101 includes two wide-angle lenses. The imaging unit 101 may include one wide-angle lens or three or more wide-angle lenses.

Each of the imaging elements 103a and 103b of the imaging unit 101 is connected to the image processor 104 via a parallel I/F bus. Further, each of the imaging elements 103a and 103b of the imaging unit 101 is connected to the imaging controller 105 via a serial I/F bus such as an inter-integrated circuit (I2C) bus. The image processor 104, the imaging controller 105, and the audio processor 109 are connected to the CPU 111 via a bus 110. The ROM 112, the SRAM 113, the DRAM 114, the operation unit 115, the input/output I/F 116, the short-range communication circuit 117, the electronic compass 118, the gyro sensor 119, the acceleration sensor 120, and the network I/F 121 are also connected to the bus 110.

The image processor 104 acquires respective items of image data output from the imaging elements 103a and 103b via the parallel I/F buses and performs predetermined processing on the items of image data. Thereafter, the image processor 104 combines the items of image data to generate data of an equirectangular projection image described below.

The imaging controller 105 usually functions as a master device while each of the imaging elements 103a and 103b usually functions as a slave device. The imaging controller 105 sets commands and the like in the group of registers of each of the imaging elements 103a and 103b via the I2C bus. The imaging controller 105 receives various commands from the CPU 111. The imaging controller 105 further acquires status data and the like of the group of registers of each of the imaging elements 103a and 103b via the I2C bus. The imaging controller 105 sends the obtained status data and the like to the CPU 111.

The imaging controller 105 instructs the imaging elements 103a and 103b to output the image data at the time when a shutter button of the operation unit 115 is pressed. In an example, the image capturing apparatus 10 displays a preview image or a moving image (movie) on a display. Examples of the display include a display of a smartphone or any other external terminal that performs short-range communication with the image capturing apparatus 10 through the short-range communication circuit 117. In the case of displaying a movie, image data are continuously output from the imaging elements 103a and 103b at a predetermined frame rate (expressed in frames per minute).

As described below, the imaging controller 105 operates in cooperation with the CPU 111 to synchronize the time when the imaging element 103a outputs image data and the time when the imaging element 103b outputs the image data. In the present embodiment, the image capturing apparatus 10 does not include a display unit (or display). In another embodiment, the image capturing apparatus 10 may include a display unit. The microphone 108 converts sound to audio (signal) data. The audio processor 109 acquires the audio data output from the microphone 108 via an I/F bus and performs predetermined processing on the audio data.

The CPU 111 controls the overall operation of the image capturing apparatus 10 and performs predetermined processing. The ROM 112 stores various programs to be executed by the CPU 111. Each of the SRAM 113 and the DRAM 114 operates as a work memory to store programs to be executed by the CPU 111 or data being currently processed. More specifically, in one example, the DRAM 114 stores image data currently processed by the image processor 104 and data of the equirectangular projection image on which processing has been performed.

The operation unit 115 collectively refers to various operation keys, a power switch, a shutter button, a touch panel having both the display and operation functions, and so on. The user operates the operation unit 115 to input various image capturing modes or image capturing conditions.

The input/output I/F 116 collectively refers to an interface circuit such as a USB I/F that allows the image capturing apparatus 10 to communicate with an external medium such as a Secure Digital (SD) card or an external personal computer. The input/output I/F 116 may be either wired or wireless. The data of the equirectangular projection image, which is stored in the DRAM 114, is stored in the external medium via the input/output I/F 116 or transmitted to an external terminal (apparatus) via the input/output I/F 116, as desired.

The short-range communication circuit 117 communicates with the external terminal (apparatus) via the antenna 117a of the image capturing apparatus 10 by short-range wireless communication technology such as near field communication (NFC), Bluetooth®, or Wi-Fi®. The short-range communication circuit 117 can transmit the data of the equirectangular projection image to the external terminal (apparatus).

The electronic compass 118 calculates an orientation of the image capturing apparatus 10 from the Earth's magnetism and outputs orientation information. The orientation information is an example of related information (metadata) in compliance with exchangeable image file format (Exif). The orientation information is used for image processing such as image correction of a captured image. The related information also includes data of a date and time when the image was captured, and data of a data size of image data. The gyro sensor 119 detects a change in tilt (roll, pitch, and yaw) of the image capturing apparatus 10 with movement of the image capturing apparatus 10. The change in tilt is one example of related information (metadata) in compliance with Exif. This information is used for image processing such as image correction of a captured image. The acceleration sensor 120 detects acceleration in three axial directions. The image capturing apparatus 10 calculates the position of the image capturing apparatus 10 (e.g., the tilt of the image capturing apparatus 10 relative to the direction of gravity), based on the acceleration detected by the acceleration sensor 120. The gyro sensor 119 and the acceleration sensor 120 of the image capturing apparatus 10 improve the accuracy of image correction.

The network I/F 121 is an interface for performing data communication using the communication network N, such as the Internet, via a router or the like.

### Hardware Configuration of Communication Terminal

FIG. 4 is a diagram illustrating an example hardware configuration of the communication terminal 30 and the information processing system 50. First, the communication terminal 30 will be described. Each hardware element of the communication terminal 30 is denoted by a reference numeral in 300 series. The communication terminal 30 is implemented by one or more computers. As illustrated in FIG. 4, the communication terminal 30 includes a CPU 301, a ROM 302, a RAM 303, a hard disk drive (HDD) 304, an HDD controller 305, a display 306, an external device connection I/F 308, a network I/F 309, a bus line 310, a keyboard 311, a pointing device 312, a digital versatile disc rewritable (DVD-RW) drive 314, a media I/F 316, an audio input/output I/F 317, a microphone 318, a speaker 319, a short-range communication circuit 320, and a camera 321.

The CPU 301 controls the overall operation of the communication terminal 30. The ROM 302 stores a program used for driving the CPU 301, such as an initial program loader (IPL). The RAM 303 is used as a work area for the CPU 301. The HDD 304 stores various types of data such as a program. The HDD controller 305 controls reading or writing of various types of data from or to the HDD 304 under the control of the CPU 301. The display 306 displays various types of information such as a cursor, a menu, a window, characters, and an image. The display 306 is an example of a display unit. In one example, the display 306 is a touch panel display provided with input means. The external device connection I/F 308 is an interface for connecting to various external devices. The external devices include, but are not limited to, a USB memory and a printer. The network I/F 309 is an interface for performing data communication using the communication network N. The bus line 310 is, for example, an address bus or a data bus for electrically connecting the hardware elements illustrated in FIG. 4, such as the CPU 301, to each other.

The keyboard 311 is an example of an input means including a plurality of keys for inputting characters, numerical values, various instructions, and the like. The pointing device 312 is an example of an input means used for selecting or executing various instructions, selecting a target for processing, or moving a cursor being displayed. The input means are not limited to the keyboard 311 and the pointing device 312 and may include a touch panel and a voice input device. The DVD-RW drive 314 controls reading or writing of various types of data from or to a DVD-RW 313, which is an example of a removable recording medium. A DVD-R, a Blu-ray Disc®, or any other recording medium may be used instead of the DVD-RW 313. The media I/F 316 controls reading or writing (storing) of data from or to a recording medium 315 such as a flash memory. The microphone 318 is an example of a built-in sound collecting means for receiving input sounds. The audio input/output I/F 317 is a circuit for controlling input and output of audio signals between the microphone 318 and the speaker 319 under the control of the CPU 301. The short-range communication circuit 320 communicates with the external terminal (apparatus) using short-range wireless communication technology such as NFC, Bluetooth®, or Wi-Fi®. The camera 321 is an example of a built-in image capturing means for capturing an image of an object to obtain image data. In one example, the microphone 318, the speaker 319, and the camera 321 are devices external to the communication terminal 30 as an alternative to built-in devices.

### Hardware Configuration of Information Processing System

As illustrated in FIG. 4, each hardware element of the information processing system 50 is denoted by a reference numeral in 500 series in parentheses. The information processing system 50 is implemented by one or more computers and has substantially the same configuration as that of the communication terminal 30, as illustrated in FIG. 4, and thus the description of the hardware elements of the information processing system 50 will be omitted.

Each of the programs described above may be recorded as a file in a format installable or executable on a computer-readable recording medium for distribution. Examples of the recording medium include a compact disc recordable (CD-R), a digital versatile disc (DVD), a Blu-ray Disc®, an SD card, and a USB memory. The recording medium may be provided in the form of a program product to domestic or foreign users. For example, the communication terminal 30 executes a program according to an embodiment of the present disclosure to implement an image display method according to an embodiment of the present disclosure.

### Wide-View Image and Point-of-View Information

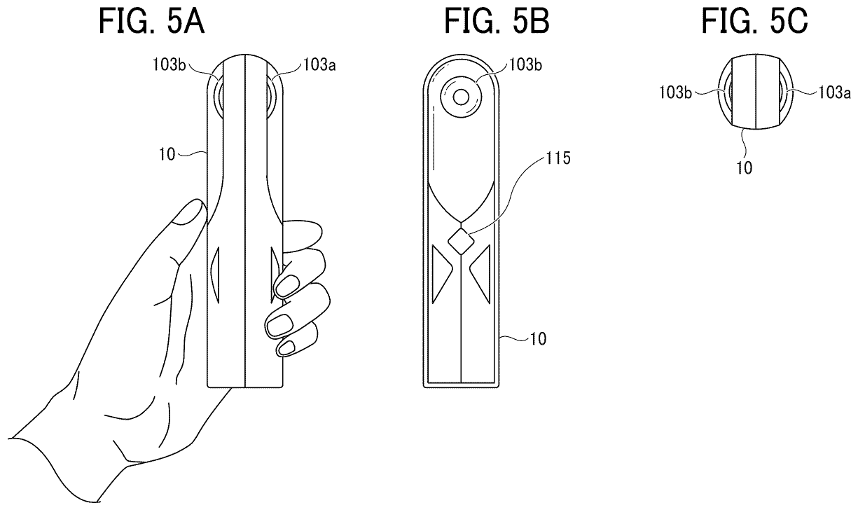

A method for generating a wide-view image (spherical image) will be described hereinafter with reference to FIGS. 5A to 12.

First, the external appearance of the image capturing apparatus 10 will be described with reference to FIGS. 5A to 5C. The image capturing apparatus 10 is a digital camera for capturing images from which a 360-degree spherical image is generated. FIG. 5A is a left side view of the image capturing apparatus 10. FIG. 5B is a front view of the image capturing apparatus 10. FIG. 5C is a plan view of the image capturing apparatus 10. The illustrated external view of the image capturing apparatus 10 is merely an example. The image capturing apparatus 10 may have any other external appearance.

As illustrated in FIG. 5A, the image capturing apparatus 10 has a size such that a person can hold the image capturing apparatus 10 with one hand. The illustrated shape of the image capturing apparatus 10 is an example. The image capturing apparatus 10 may have any other shape. As illustrated in FIGS. 5A, 5B, and 5C, the imaging element 103a and the imaging element 103b are disposed in an upper portion of the image capturing apparatus 10 such that the imaging element 103a is disposed on the front side and the imaging element 103b is disposed on the back side. The imaging elements (image sensors) 103a and 103b are used in combination with optical members (e.g., the lenses 102a and 102b described above), each being configured to capture a hemispherical image having an angle of view of greater than or equal to 180 degrees. As illustrated in FIG. 5B, the operation unit 115, such as a shutter button, is disposed on the back surface of the image capturing apparatus 10. As described above, the image capturing apparatus 10 may include one imaging element or three or more imaging elements.

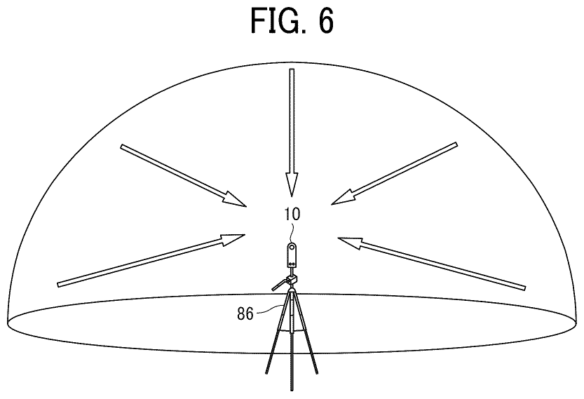

Next, a situation in which the image capturing apparatus 10 is used will be described with reference to FIG. 6. FIG. 6 is an illustration of an example of how the image capturing apparatus 10 is used. As illustrated in FIG. 6, for example, the image capturing apparatus 10 is used for capturing an image of an object surrounding the image capturing apparatus 10. Each of the imaging elements 103a and 103b illustrated in FIGS. 5A to 5C captures an image of an object surrounding the image capturing apparatus 10. As a result, two hemispherical images are obtained.

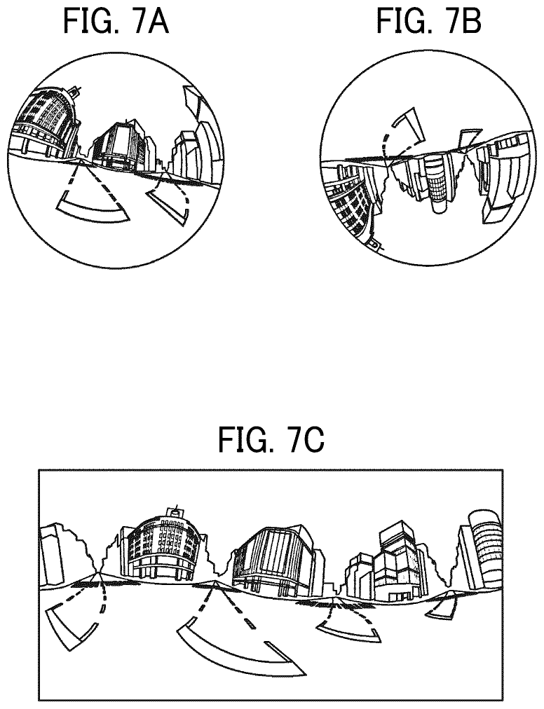

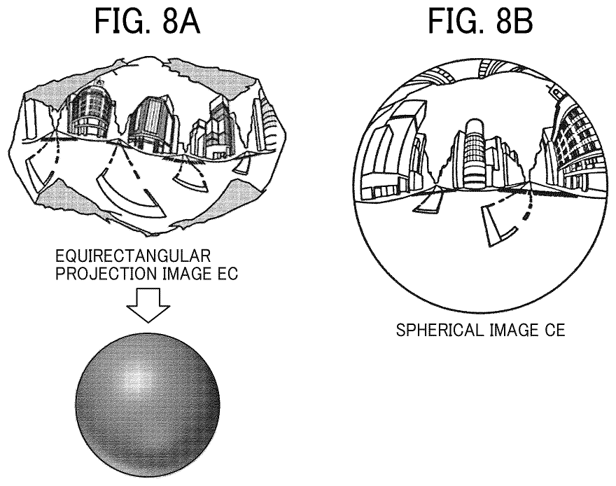

Next, an overview of a process for generating a spherical image from images captured by the image capturing apparatus 10 will be described with reference to FIGS. 7A to 7C and FIGS. 8A and 8B. FIG. 7A illustrates a hemispherical image (front side) captured by the image capturing apparatus 10. FIG. 7B illustrates a hemispherical image (back side) captured by the image capturing apparatus 10. FIG. 7C illustrates an image in equirectangular projection (hereinafter referred to as an “equirectangular projection image” or an “equidistant cylindrical projection image”). FIG. 8A conceptually illustrates how the equirectangular projection image is mapped to a surface of a sphere. FIG. 8B illustrates a spherical image.

As illustrated in FIG. 7A, an image obtained by the imaging element 103a is a curved hemispherical image (front side) captured through the lens 102a described above. As illustrated in FIG. 7B, an image captured by the imaging element 103b is a curved hemispherical image (back side) captured through the lens 102b described above. The image capturing apparatus 10 combines the hemispherical image (front side) and the hemispherical image (back side), which are flipped by 180 degrees, to create an equirectangular projection image EC as illustrated in FIG. 7C.

The image capturing apparatus 10 uses software such as OpenGL ES to map the equirectangular projection image EC to a sphere so as to cover the surface of the sphere, as illustrated in FIG. 8A. As a result, the image capturing apparatus 10 generates a spherical image (or spherical panoramic image) CE as illustrated in FIG. 8B. That is, the spherical image CE is represented as the equirectangular projection image EC, which corresponds to a surface facing the center of the sphere. OpenGL ES is a graphics library used for visualizing two-dimensional (2D) data and three-dimensional (3D) data. OpenGL ES is an example of software for executing image processing. Any other software may be used to create the spherical image CE. The spherical image CE may be either a still image or a moving image.

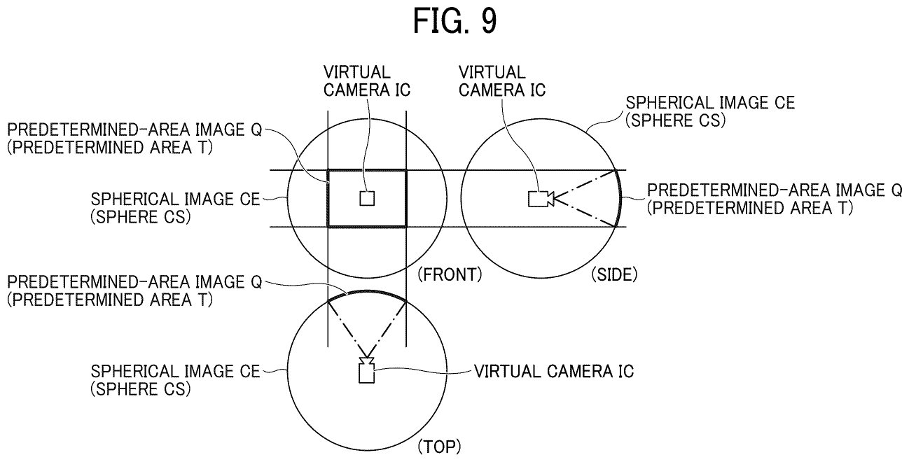

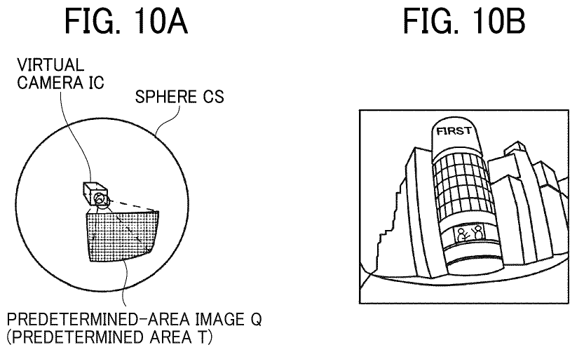

As described above, since the spherical image CE is an image mapped to a sphere so as to cover the surface of the sphere, part of the image may look distorted when viewed by a user, providing a strange feeling. Accordingly, the image capturing apparatus 10 displays an image of a predetermined area T, which is part of the spherical image CE, as a planar image having fewer curves to make the user feel comfortable. The predetermined area is, for example, a part of the spherical image CE that is viewable by the user. In this disclosure, the image of the predetermined area, which is viewable, may be referred to as a “predetermined-area image” or “viewable-area image” Q. That is, the term “predetermined-area image” and “viewable-area image” may be used interchangeably. The display of the predetermined-area image will be described with reference to FIGS. 9, 10A, and 10B.

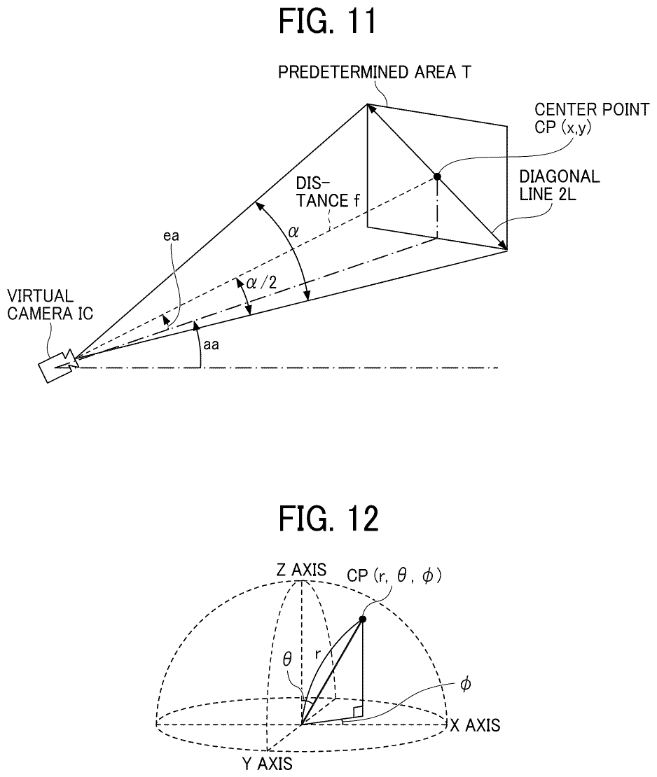

FIG. 9 is a diagram illustrating the position of a virtual camera IC and the position of the predetermined area T in a case where the spherical image CE is of a three-dimensional sphere CS. The virtual camera IC corresponds to a position of a point of view (viewpoint) of a user who is viewing the spherical image CE represented as a surface area of the three-dimensional solid sphere CS. FIG. 10A is a perspective view of the virtual camera IC and the predetermined area T illustrated in FIG. 9, and FIG. 10B is a diagram illustrating the predetermined-area image displayed on a display. In FIG. 10A, the spherical image CE illustrated in FIG. 9 is represented by the three-dimensional sphere CS. Assuming that the spherical image CE generated in the way described above is a surface area of the sphere CS, the virtual camera IC is inside the spherical image CE as illustrated in FIG. 9. The predetermined area T in the spherical image CE is an imaging area of the virtual camera IC. Specifically, the predetermined area T is specified by predetermined-area information indicating an imaging direction and an angle of view of the virtual camera IC in a three-dimensional virtual space containing the spherical image CE. Zooming in or out of the predetermined area T may be implemented by bringing the virtual camera IC closer to or farther away from the spherical image CE. The predetermined-area image Q is the image of the predetermined area T in the spherical image CE. The predetermined area T is defined by an angle of view α of the virtual camera IC and a distance f from the virtual camera IC to the spherical image CE (see FIG. 11).

The predetermined-area image Q illustrated in FIG. 10A is displayed on a predetermined display as an image of the imaging area of the virtual camera IC, as illustrated in FIG. 10B. The image illustrated in FIG. 10B is a predetermined-area image represented by predetermined-area information that is set by default. A description will be made using the imaging direction (ea, aa) and the angle of view (α) of the virtual camera IC. In another example, the predetermined area T is not defined by the angle of view α and the distance f, and the imaging area of the virtual camera IC, which is the predetermined area T, is identified by position coordinates (X, Y, Z).

Next, the relationship between the predetermined-area information and the image of the predetermined area T will be described with reference to FIG. 11. FIG. 11 is a diagram illustrating the relationship between the predetermined-area information and the image of the predetermined area T. As illustrated in FIG. 11, “ea” denotes an elevation angle, “aa” denotes an azimuth angle, and “α” denotes an angle of view of the virtual camera IC. The position of the virtual camera IC is adjusted such that the point of gaze of the virtual camera IC, indicated by the imaging direction (ea, aa), matches a center point CP (x, y) of the predetermined area T serving as the imaging area of the virtual camera IC. As illustrated in FIG. 11, the center point CP (x, y) of the predetermined area T, whose diagonal angle of view is represented by the angle of view α of the virtual camera IC and is denoted by α, is used as a parameter (x, y) of the predetermined-area information. The predetermined-area image Q is the image of the predetermined area T in the spherical image CE. The distance f is the distance from the virtual camera IC to the center point CP (x, y) of the predetermined area T. The distance between the center point CP (x, y) and a given vertex of the predetermined area T is denoted by “L” (2L is a diagonal line). In FIG. 11, a trigonometric function generally expressed by Equation (1) below holds.

$$L / f = tan ( \frac{α}{2} ) \qquad ( 1 )$$

The image capturing apparatus 10 described above is an example of an image capturing apparatus for acquiring a wide-view image. The spherical image CE is an example of a wide-view image. The wide-view image is generally an image captured with a wide-angle lens such as a lens that can capture an image of a range wider than a range that the human eye can perceive.

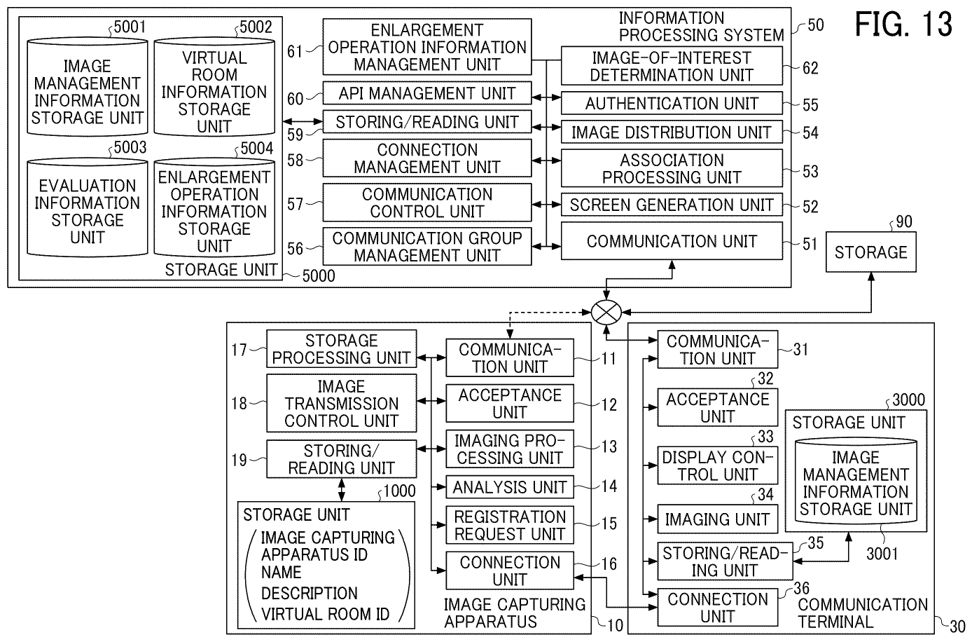

FIG. 12 is a diagram illustrating the relationship illustrated in FIG. 11 using a point in a three-dimensional Euclidean space defined in spherical coordinates. The center point CP illustrated in FIG. 11 is represented by a spherical polar coordinate system to obtain position coordinates (r, θ, φ). The position coordinates (r, θ, φ) represent a radius vector, a polar angle, and an azimuth angle, respectively. The radius vector r is the distance from the origin of the three-dimensional virtual space including the spherical image CE to the center point CP. Accordingly, the radius vector r is equal to the distance f illustrated in FIG. 11. FIG. 12 illustrates the relationship illustrated in FIG. 11. In the following description, the position coordinates (r, θ, φ) of the virtual camera IC are used as an example of point-of-view information. As described above, the point-of-view information is any parameter information that can define the predetermined area T (the predetermined-area image Q) displayed on the predetermined display illustrated in FIG. 10A as the image of the imaging area of the virtual camera IC. The point-of-view information includes the coordinates of the diagonal vertices of the predetermined area T. In an example, the point-of-view information includes information indicating the angle of view α of the virtual camera IC and information indicating the center point CP (x, y), which have been described with reference to FIG. 11. Examples of the point-of-view information include position coordinate information in the form of spherical coordinates, position coordinate information in the form of orthogonal coordinates, and a difference value between the predetermined-area information that is set by default and the coordinates. Other examples of the point-of-view information include information other than coordinate information, such as an angle and a distance, as illustrated in FIG. 11. While the center point CP of the predetermined area T is used as a reference in FIGS. 11 and 12, parameter information may be based on any one of the vertices of the predetermined area T. In the foregoing description of the point-of-view information, as a non-limiting example, the wide-view image is a spherical image. In another wide-view image, information that defines the predetermined area T in the other wide-view image is point-of-view information.

### Functions

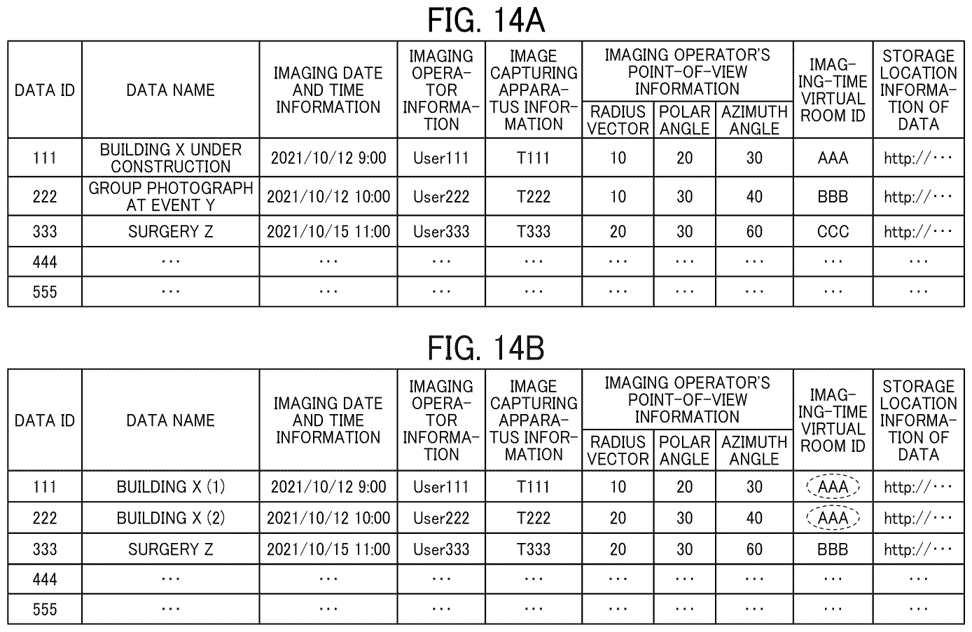

Next, the functional configuration of the communication system 1 will be described with reference to FIG. 13. FIG. 13 is a diagram illustrating an example functional configuration of the communication system 1. FIG. 13 illustrates functions, related to processes or operations described below, of the terminals, the apparatus, and the server illustrated in FIG. 1.

### Functional Configuration of Image Capturing Apparatus

First, the functional configuration of the image capturing apparatus 10 will be described with reference to FIG. 13. The image capturing apparatus 10 includes a communication unit 11, an acceptance unit 12, an imaging processing unit 13, an analysis unit 14, a registration request unit 15, a connection unit 16, a storage processing unit 17, an image transmission control unit 18, and a storing/reading unit 19. Each unit is a function or means implemented by or caused to function by one or more of the hardware elements illustrated in FIG. 3 operating in accordance with instructions from the CPU 111 according to a program loaded onto the SRAM 113 or the DRAM 114. The image capturing apparatus 10 further includes a storage unit 1000, which is implemented by, for example, the ROM 112 illustrated in FIG. 3.

The communication unit 11 is a function of connecting to the communication network N by using wireless communication technology such as Wi-Fi® to transmit and receive various types of data or information to and from another apparatus. In the present embodiment, the connection unit 16 transmits a wide-view image acquired by the imaging processing unit 13 to the information processing system 50. In another embodiment, the communication unit 11 may transmit the wide-view image to the information processing system 50.

The acceptance unit 12 is a function of accepting an operation input to the image capturing apparatus 10 from the user. The acceptance unit 12 accepts the operation of turning on or off the power, turning on or off the shutter button (start or stop of transmission of the wide-view image), or any other operation.

The imaging processing unit 13 captures an image of an object or surroundings such as scenery and acquires a captured image. The captured image acquired by the imaging processing unit 13 may be either a moving image or a still image, or both. In another example, the captured image may include an image and audio. Further, for example, the imaging processing unit 13 captures an image of a two-dimensional code displayed on the display 306 of the communication terminal 30.

The analysis unit 14 analyzes the two-dimensional code, of which the image is captured by the imaging processing unit 13, to extract information included in the two-dimensional code. The extracted information includes a URL for registering the image capturing apparatus 10 in the tenant, a temporary ID, and a password.

The registration request unit 15 transmits a request to the information processing system 50 to register the image capturing apparatus 10 in the tenant in the information processing system 50, by using the information included in the two-dimensional code read by the analysis unit 14.

The connection unit 16 is a function of receiving a supply of power from the communication terminal 30A and performing data communication. The connection unit 16 is implemented by, for example, the short-range communication circuit 117.

The storage processing unit 17 performs a process of storing a wide-view image captured in response to an image capturing request from any site in a URL (e.g., a URL that specifies the storage 90) transmitted from the information processing system 50.

The image transmission control unit 18 is a function of controlling transmission of the wide-view image to the information processing system 50. For example, the image transmission control unit 18 transmits a captured image acquired by the imaging processing unit 13 to the information processing system 50 periodically or in response to a user operation when the captured image is a still image, or at a predetermined frame rate (expressed in frames per second, or FPS) when the captured image is a moving image. The image transmission control unit 18 also performs switching between the communication unit 11 and the connection unit 16.

The storing/reading unit 19 is a function of storing various types of data in the storage unit 1000 or reading various types of data from the storage unit 1000. The storage unit 1000 stores captured image data acquired by the imaging processing unit 13, an image capturing apparatus ID, and the like. The captured image data stored in the storage unit 1000 may be deleted when a predetermined amount of time has elapsed after the captured image data was acquired by the imaging processing unit 13, or the data transmitted to the information processing system 50 may be deleted.

The image capturing apparatus 10 has installed therein an application (also referred to as a plug-in) for supporting the communication system 1. The application is not used when the image capturing apparatus 10 is a commercially available image capturing apparatus, but otherwise is used to associate the image capturing apparatus 10 with the virtual room or to receive external control. Some of the functions illustrated in FIG. 13, such as the registration request unit 15, are implemented by the application.

### Functional Configuration of Communication Terminal

Next, the functional configuration of the communication terminal 30 will be described with reference to FIG. 13. The communication terminal 30 includes a communication unit 31, an acceptance unit 32, a display control unit 33, an imaging unit 34, a storing/reading unit 35, and a connection unit 36. Each unit is a function or means implemented by or caused to function by one or more of the hardware elements illustrated in FIG. 4 operating in accordance with instructions from the CPU 301 according to a program (either the web browser or a dedicated application) loaded onto the RAM 303. The communication terminal 30 further includes a storage unit 3000, which is implemented by the ROM 302 or the recording medium 315 illustrated in FIG. 4.

The communication unit 31 is a function of connecting to the communication network N and transmitting and receiving various types of data or information to and from another apparatus. The communication unit 31 is implemented by, for example, the network I/F 309.

The acceptance unit 32 is a function of accepting various selections or operation inputs to the communication terminal 30. The display control unit 33 is a function of causing the display 306 of the communication terminal 30 to display a wide-view image, an image having a normal angle of view, and various screens. For example, the display control unit 33 causes the display 306 to display a two-dimensional code transmitted from the information processing system 50. In one example, the two-dimensional code is QR Code®, a DataMatrix (DataCode) code, a MaxiCode code, or a PDF417 code. In another example, the two-dimensional code is a barcode.

The connection unit 36 is a function of supplying power to the image capturing apparatus 10 and performing data communication. The connection unit 36 is implemented by, for example, the short-range communication circuit 320.

The storing/reading unit 35 is a function of storing various types of data in the storage unit 3000 or reading various types of data from the storage unit 3000 in accordance with instructions from the CPU 301 illustrated in FIG. 4. The storage unit 3000 includes an image management information storage unit 3001. The image management information storage unit 3001 will be described in the description of the information processing system 50.

### Functional Configuration of Information Processing System

Next, the functional configuration of the information processing system 50 will be described. The information processing system 50 includes a communication unit 51, a screen generation unit 52, an association processing unit 53, an image distribution unit 54, an authentication unit 55, a communication group management unit 56, a communication control unit 57, a connection management unit 58, a storing/reading unit 59, an API management unit 60, an enlargement operation information management unit 61, and an image-of-interest determination unit 62. Each unit is a function or means implemented by or caused to function by one or more of the hardware elements illustrated in FIG. 4 operating in accordance with instructions from the CPU 501 according to a program loaded onto the RAM 503. The information processing system 50 further includes a storage unit 5000. The storage unit 5000 is implemented by the ROM 502, the HDD 504, or the recording medium 515 illustrated in FIG. 4.

The communication unit 51 has a function of transmitting and receiving various types of data or information to and from another apparatus via the communication network N.

The screen generation unit 52 generates screen information to be displayed on the communication terminal 30. The screen information is created by Hypertext Markup Language (HTML), Extensible Markup Language (XML), Cascade Style Sheet (CSS), JavaScript®, or any other language for a web application to be executed by the communication terminal 30. For a native application to be executed by the communication terminal 30, the screen information is held by the communication terminal 30, and the information to be displayed is transmitted in XML or the like. The screen generation unit 52 generates screen information of a screen on which a wide-view image or the like distributed by the image distribution unit 54 is arranged.

The association processing unit 53 performs control related to sharing of the point-of-view information of the wide-view image. In response to receipt of an image capturing request together with point-of-view information from the communication terminal 30, the association processing unit 53 performs a process for associating the point-of-view information with a wide-view image acquired from the image capturing apparatus 10 in response to an image capturing request. The association processing unit 53 stores the wide-view image and the point-of-view information, which are associated with each other, in an image management information storage unit 5001. Further, the association processing unit 53 transmits a URL, which is information indicating a storage location where the associated wide-view image and point-of-view information are to be stored, to the communication terminal 30. In one example, the information processing system 50 does not simultaneously receive the point-of-view information and the image capturing request from the communication terminal 30. The information processing system 50 separately receives the point-of-view information and the image capturing request and performs association processing. The URL is an example of information indicating the storage location. The information indicating the storage location may be in any other format such as a uniform resource identifier (URI).

The image distribution unit 54 distributes, to the communication terminal 30 operated by a user who is in the virtual room, a wide-view image transmitted from the image capturing apparatus 10 associated with the same virtual room. An image having a normal angle of view captured by a camera included in the communication terminal 30 or the camera 8 or 9 connected to the communication terminal 30 is also distributed in a similar manner.

The authentication unit 55 is a function of authenticating a request source in response to an authentication request received by the communication unit 51. For example, the authentication unit 55 determines whether authentication information (a user ID and a password) included in the authentication request received by the communication unit 51 matches authentication information held in advance to perform user authentication. The authentication information may be a card number of an integrated circuit (IC) card or biometric authentication information such as a face, a fingerprint, or a voiceprint. The authentication unit 55 may perform authentication using an external authentication system or an authentication method such as Open Authorization (OAuth).

The communication group management unit 56 manages the entry of the communication terminal 30 or the user into the virtual room, association between the virtual room and a device, and the like. Upon successful authentication of the user by the authentication unit 55, the communication group management unit 56 registers the user ID and the Internet protocol (IP) address of the communication terminal 30 in a virtual room information storage unit 5002 or associates the image capturing apparatus 10 with the virtual room.

The communication control unit 57 manages the start, establishment, and end of communication with the image capturing apparatus 10 associated with each virtual room. The communication control unit 57 also manages the start, establishment, and end of communication for distributing a wide-view image or audio in response to the communication terminal 30 entering or leaving the virtual room.

The connection management unit 58 manages communication (connection) established with the information processing system 50 by the communication terminal 30 and the image capturing apparatus 10 in association with the virtual room.

The API management unit 60 manages an API to be used by a platform contractor to provide an image distribution service of a wide-view image. In the use of the API, the platform contractor develops software for calling the API. The software to be developed may operate on a server or may operate on a client such as a communication terminal. Any of the functions of the information processing system 50, such as the image distribution unit 54, the association processing unit 53, and the communication control unit 57, can be provided as an API. Any function added to the information processing system 50 later may be provided as an API. To determine whether to provide a function as an API, a communication terminal operated by the platform provider accesses the information processing system 50 and receives the public settings of the API. As a result, the API management unit 60 can control the API based on the public settings. The API management unit 60 may perform an authentication process for checking whether software operating on a requesting entity that makes a request to call the API is software developed by an authorized platform contractor. The authentication process can be performed by comparing information stored in a platform contractor information storage unit with information transmitted from the software operating on the requesting entity. In a specific example of the authentication process, the information processing system 50 receives, from the software operating on the requesting entity, an application ID issued to the software developed by the platform contractor in advance by the API management unit 60. If the API management unit 60 determines that the application ID matches an application ID stored in the platform contractor information storage unit, the API management unit 60 performs control to give permission to provide an API since the software developed by the platform contractor is determined to be valid. The platform contractor information storage unit may be implemented by any desired memory accessible from the information processing system 50. If the software developed by the platform contractor is not determined to be valid, the API management unit 60 performs control not to give permission to provide an API. The application ID is an example of authentication information for determining validity. The API management unit 60 may use authentication information issued in advance by the API management unit 60 of the information processing system 50 or by an external system to check the validity of the requesting entity. Examples of such authentication information as issued in advance include an access token, a ticket, a security key, a password, and a personal identification number (PIN) code. In the present embodiment, while the use of a function of the information processing system 50 as an API is not described, the same process flow is performed, except that software such as an application developed by a platform contractor uses a function of the information processing system 50 through a determination made by the API management unit 60.

The enlargement operation information management unit 61 records, in an enlargement operation information storage unit 5004, information indicating which user is displaying which shared image in an enlarged manner and enlargement operation information related to an enlargement operation, based on enlargement operation information transmitted from the communication terminal 30. Further, the enlargement operation information management unit 61 records, for each user, the presence or absence of an enlargement operation to be performed on an image from each site, and the like in an evaluation information storage unit 5003. The presence or absence of an enlargement operation to be performed on a shared image includes the presence or absence of enlargement of the entire image (window size), and the presence or absence of enlargement of a partial region of the image.

The image-of-interest determination unit 62 determines a shared image of interest and a region of interest in the shared image of interest, based on, for example, the presence or absence of an enlargement operation to be performed on an image by each user.

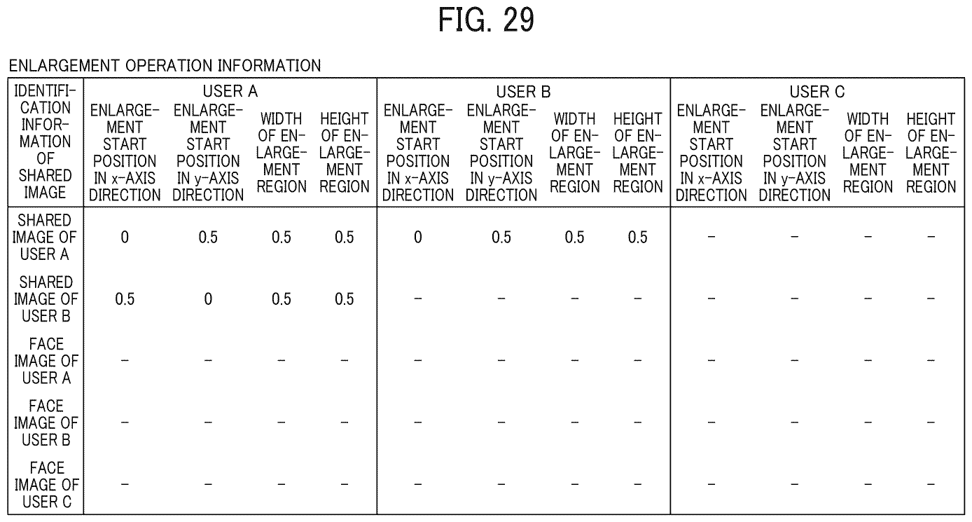

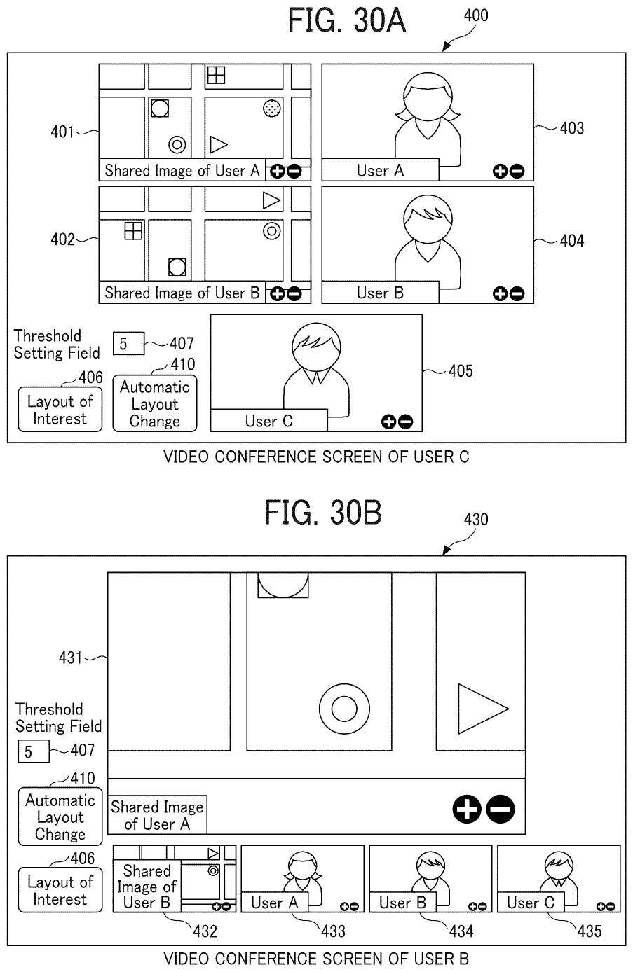

The storing/reading unit 59 is a function of storing various types of data in the storage unit 5000 or reading various types of data from the storage unit 5000. The storage unit 5000 includes the image management information storage unit 5001, the virtual room information storage unit 5002, the evaluation information storage unit 5003, and the enlargement operation information storage unit 5004. The evaluation information storage unit 5003 and the enlargement operation information storage unit 5004 will be described below with reference to FIGS. 28 and 29, respectively.

### Image Management Information Storage Unit 5001

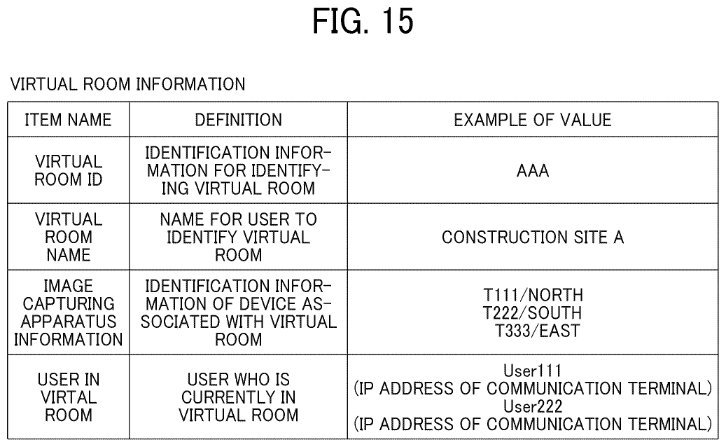

FIG. 14A is a table illustrating image management information stored in the image management information storage unit 5001. The image management information storage unit 5001 stores image management information as illustrated in FIG. 14A or 14B. The image management information is information for managing wide-view images captured in response to image capturing requests. In response to a user transmitting an image capturing request from the communication terminal 30, image management information for one record is generated. The items contained in the image management information will be described.

The item “data ID” is identification information that identifies a wide-view image. The information processing system 50 assigns a number to each data ID. ID is an abbreviation for identification and means an identifier or identification information. ID is any one or a combination of two or more of a name, a symbol, a character string, and a numerical value that are used for uniquely identifying a specific object from among a plurality of objects.

The item “data name” is the name of a wide-view image set by the user of the communication terminal 30. Each data name may be set by the user or automatically.

The item “imaging date and time information” is information that specifies the imaging date and time of a wide-view image. Examples of the imaging date and time include the date and time when the user input an image capturing request to the communication terminal 30, and the date and time when the image capturing apparatus 10 captured a wide-view image. The imaging date and time information may be a time stamp of a wide-view image.

The item “imaging operator information” is identification information (or a user name) of a user (imaging operator) who has input an image capturing request to the communication terminal 30. Since a user inputs an image capturing request to the communication terminal 30 after entering the virtual room, a user registered in the imaging operator information is identified by authentication to the information processing system 50 or the virtual room. The imaging operator information is transmitted to the information processing system 50 together with an image capturing request.

The item “image capturing apparatus information” is identification information (image capturing apparatus ID) of the image capturing apparatus 10 that has captured a wide-view image. The information processing system 50 assigns a number to each image capturing apparatus ID and shares the image capturing apparatus ID with the image capturing apparatus 10. The image capturing apparatus ID may be information unique to the image capturing apparatus 10, such as a media access control (MAC) address or a serial number. The image capturing apparatus ID is transmitted to the information processing system 50 together with the associated wide-view image.

The item “imaging operator's point-of-view information” is point-of-view information including a radius vector, a polar angle, and an azimuth angle. The point-of-view information indicates the coordinates of the center of the wide-view image being displayed on the communication terminal 30. The point-of-view information is transmitted from the communication terminal 30 that makes an image capturing request. The point-of-view information may include information designating the width and height of the display range, in addition to the radius vector, the polar angle, and the azimuth angle. Alternatively, the point-of-view information may include the width and height of the display range.

The item “imaging-time virtual room ID” is identification information of a virtual room associated with the image capturing apparatus 10.

The item “storage location information of data” is a URL, a file path, or the like of a location where a wide-view image is stored. The wide-view image may be a moving image. When the wide-view image is a moving image, a radius vector, a polar angle, and an azimuth angle as in the imaging operator's point-of-view information are stored in association with the elapsed time of the conference (the period of time during which the moving image is captured).

FIG. 14B is also a table illustrating image management information. In FIG. 14B, wide-view images having the same imaging-time virtual room ID are stored. The image management information may be classified in units of virtual rooms.

### Virtual Room Information Storage Unit 5002

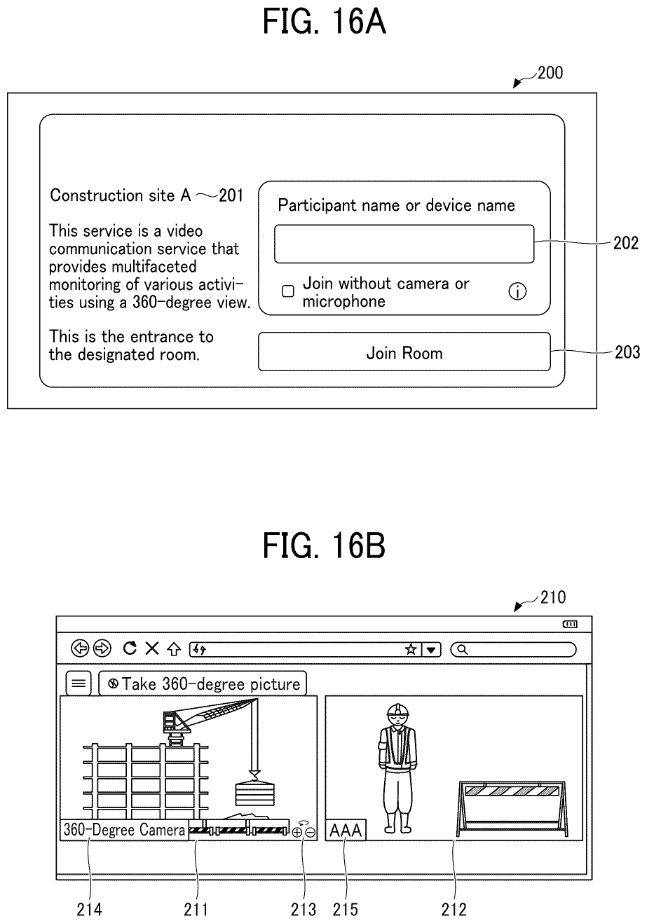

FIG. 15 is a table illustrating virtual room information stored in the virtual room information storage unit 5002. The virtual room information storage unit 5002 stores virtual room information as illustrated in FIG. 15. The virtual room information is information related to a virtual room. The virtual room information is held for each virtual room. The items contained in the virtual room information will be described. The virtual room is registered in the tenant.

The item “virtual room ID” is identification information that identifies the virtual room. In the present embodiment, each virtual room can be created by a user as appropriate.

The item “virtual room name” is a name for the user to identify the virtual room. Each virtual room name can be set by a user as appropriate.

The item “image capturing apparatus information” is identification information (image capturing apparatus ID) of an image capturing apparatus 10 associated with the virtual room. The item “user in virtual room” is the user ID of a user who has entered and is currently in the virtual room. The user is a user authorized to view a wide-view image. The method for entering a virtual room will be described below. The user ID is associated with the IP address of the communication terminal 30 operated by the user.

Entry of Communication Terminal into Virtual Room

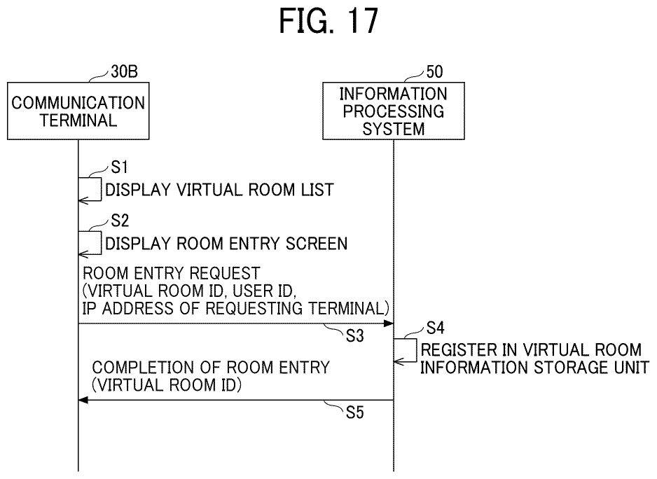

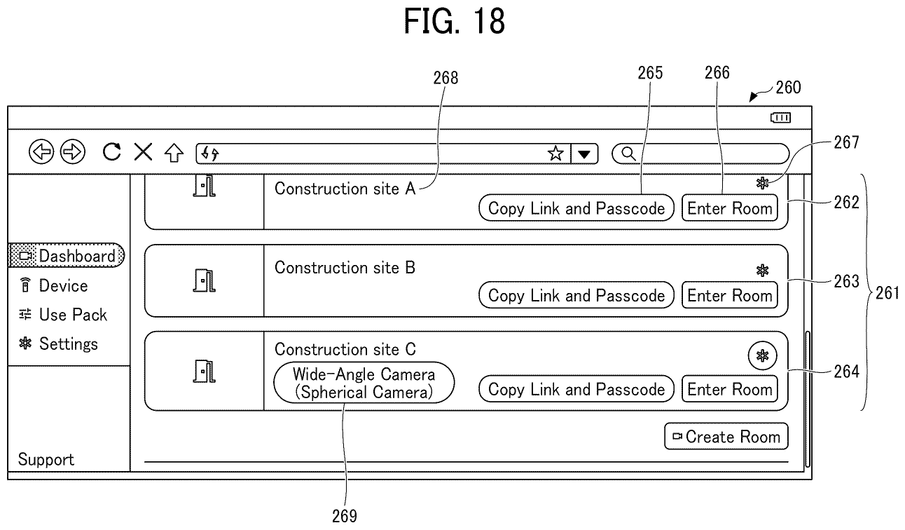

Next, a process in which the user B enters a virtual room will be described with reference to FIGS. 16A, 16B, and 17. In the illustrated example, the image capturing apparatus 10 has already been associated with the virtual room, and the communication terminal 30A has transmitted a wide-view image and an image having a normal angle of view to the information processing system 50. The association of the image capturing apparatus 10 with the virtual room and other operations will be described with reference to FIG. 17 and the subsequent figures. In the following description, no distinction is made between the entry of the user B into the virtual room and the entry of the communication terminal 30B, which is operated by the user B, into the virtual room.

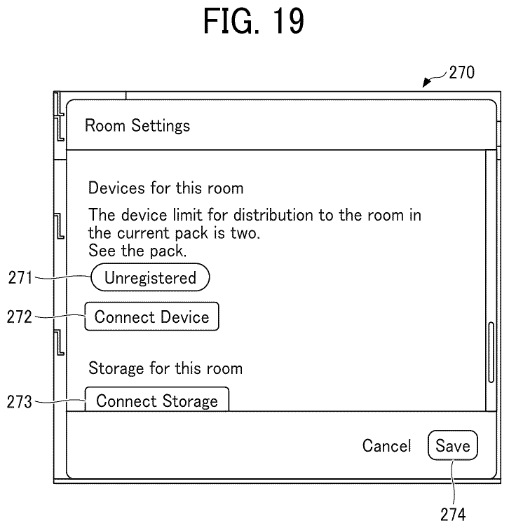

FIGS. 16A and 16B illustrate examples of a screen displayed on the communication terminal 30B when the user B is to enter the virtual room. FIG. 16A illustrates an example of a room entry screen 200. Prior to the display of the room entry screen 200, the user B logs in to the information processing system 50. Upon login of the user B, the tenant to which the user B belongs is identified. Virtual rooms are associated with the tenant. A list of virtual rooms associated with the tenant is displayed on the communication terminal 30B (see FIG. 18), and the user B selects a virtual room that the user B is to enter from the list. FIG. 16A illustrates the room entry screen 200 for the virtual room selected by the user B.

Alternatively, the creator of the virtual room may request the information processing system 50 to issue a URL corresponding to the virtual room, and the URL may be transmitted to the user B via email or any other means. In response to the user B clicking on the URL displayed on the communication terminal 30B, the communication terminal 30B displays the room entry screen 200 illustrated in FIG. 16A.

The room entry screen 200 includes a virtual room name 201, a participant name input field 202, and a room entry button 203. The virtual room name 201 is the same as that stored in the virtual room information storage unit 5002. The participant name input field 202 may include a name such as a nickname of the user B. Upon the login of the user B, the user name of the user B is identified. The identified user name may be automatically displayed. The room entry button 203 is a button for the user B to send a request to enter the virtual room.

At the time of entry into the virtual room, authentication for entering the virtual room may be requested separately from login to the tenant.

FIG. 16B illustrates an image viewing screen 210 displayed on the communication terminal 30B upon the user B entering the virtual room. The image viewing screen 210 illustrated in FIG. 16B indicates that the image capturing apparatus 10 has already started distributing a wide-view image and that the communication terminal 30A has already started distributing an image having a normal angle of view. The image viewing screen 210 includes a first image field 211 and a second image field 212. The first image field 211 displays the wide-view image, and the second image field 212 displays the image having a normal angle of view. In one example, images are transmitted from three or more sites. The image viewing screen 210 is divided into a number of portions corresponding to the number of sites from which images are transmitted.

The first image field 211 displays a wide-view image mark 213. The wide-view image mark 213 is set by the screen generation unit 52 of the information processing system 50 based on a determination that the image to be displayed in the first image field 211 is a wide-view image. The determination may be made by the communication terminal 30B, and the communication terminal 30B may display the wide-view image mark 213. The wide-view image mark 213 allows the user B to know that the point of view can be changed. The first image field 211 also displays a device name 214. The device name 214 is transmitted from the image capturing apparatus 10 together with the wide-view image. The device name 214 is set by the user A.

The second image field 212 displays a participant name 215. The participant name 215 is a user name. The participant name of a user who has already entered the virtual room is displayed in the participant name input field 202. In the illustrated example, since the user A has already entered the virtual room, “AAA”, which is entered by the user A in the participant name input field 202, is displayed as the participant name 215.

FIG. 17 is a sequence diagram illustrating a process in which the user B (or the communication terminal 30B) enters the virtual room.

S1: First, the user B at the site B performs an operation of displaying a virtual room list screen. In response to the acceptance unit 32 accepting the operation of displaying the virtual room list screen, the display control unit 33 of the communication terminal 30B causes the display 306 to display a selection screen.

S2: In response to the user B selecting a selection button for one of the virtual rooms, the acceptance unit 32 of the communication terminal 30B accepts the selection of the virtual room. The display control unit 33 of the communication terminal 30B causes the display 306 to display the room entry screen 200.

S3: The user B completes the items and then presses the room entry button 203. In response to the acceptance unit 32 accepting the pressing of the room entry button 203, the communication unit 31 of the communication terminal 30B transmits a request to the information processing system 50 to enter the virtual room. The request for entering the virtual room includes a virtual room ID indicating the virtual room selected in step S2, the user ID of the user B, who is a login user, and the IP address of the communication terminal 30B from which the request is transmitted.

S4: The communication unit 51 of the information processing system 50 receives the request for entering the virtual room. The communication group management unit 56 registers the IP address and the user ID of the login user in the virtual room information identified by the virtual room ID in the virtual room information storage unit 5002.

S5: The communication unit 51 of the information processing system 50 transmits, to the communication terminal 30B, a notification of the completion of the entry to the virtual room. Thus, the communication unit 31 of the communication terminal 30B receives the notification of the completion of the entry to the virtual room.

Association of Image Capturing Apparatus with Room

Next, an association of the image capturing apparatus 10 with a virtual room will be described with reference to FIGS. 18 to 22. In an example, the user A at the site A associates the image capturing apparatus 10 with a virtual room. In another example, a system administrator, a tenant administrator, or the like associates the image capturing apparatus 10 with a virtual room.

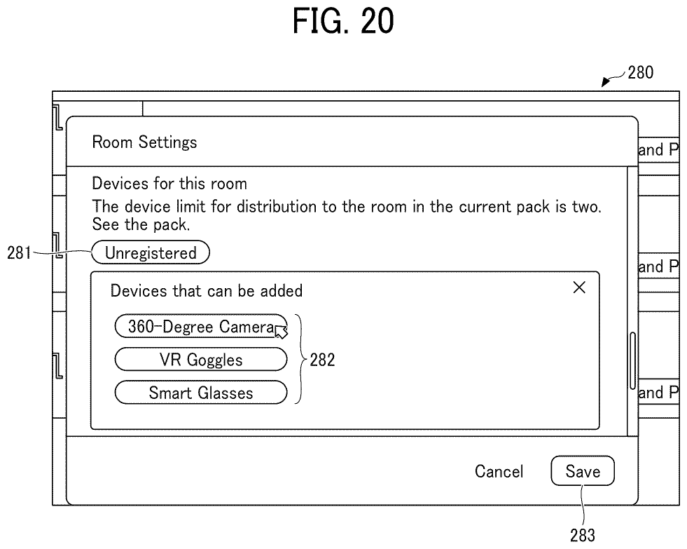

FIG. 18 illustrates an example of a first virtual room association screen 260 for associating the image capturing apparatus 10 with a virtual room. The same screen configuration may be used for the VR goggles 89 and the smart glasses 88. The first virtual room association screen 260 includes a virtual room list 261. The virtual room list 261 displays individual virtual room fields 262 to 264, based on virtual rooms created in the tenant. Each of the individual virtual room fields 262 to 264 includes a link issuance button 265, a room entry button 266, a settings button 267, and a virtual room name 268. The link issuance button 265 is a button for issuing a link (a URL for invitation) to the corresponding virtual room and a passcode. The room entry button 266 is a button for the user A to enter the virtual room. The settings button 267 is a button for associating the image capturing apparatus 10 with the virtual room. The virtual room name 268 is the same as that stored in the virtual room information storage unit 5002. The user A presses the settings button 267. In response to the pressing of the settings button 267, the communication terminal 30A displays a second virtual room association screen 270 illustrated in FIG. 19.

If a device has already been associated with the virtual room, a name 269 of the device is displayed in the individual virtual room field (in FIG. 18, the individual virtual room field 264).

FIG. 19 illustrates an example of the second virtual room association screen 270. The second virtual room association screen 270 is displayed as a pop-up on the first virtual room association screen 260. In one example, the screen transition from the first virtual room association screen 260 to the second virtual room association screen 270 is not made through the information processing system 50. In another example, the screen transition from the first virtual room association screen 260 to the second virtual room association screen 270 is made through the information processing system 50.

The second virtual room association screen 270 includes a name 271 of the image capturing apparatus 10 that is currently (or has already been) associated with the virtual room, a connection button 272, a storage button 273, and a save button 274. In FIG. 18, the name 271 is set unregistered because the image capturing apparatus 10 is not registered yet. The connection button 272 is a button for displaying a list of devices registered in the tenant. The storage button 273 is a button for displaying a list of storages 90 to store a wide-view image captured by the image capturing apparatus 10 associated with the virtual room. In response to the pressing of the connection button 272, the communication terminal 30A displays a third virtual room association screen.

The communication terminal 30A transmits a virtual room ID to the information processing system 50 and acquires the name (or ID) of a device registered in the tenant for which the virtual room is generated and the name (or ID) of a device associated with the virtual room.

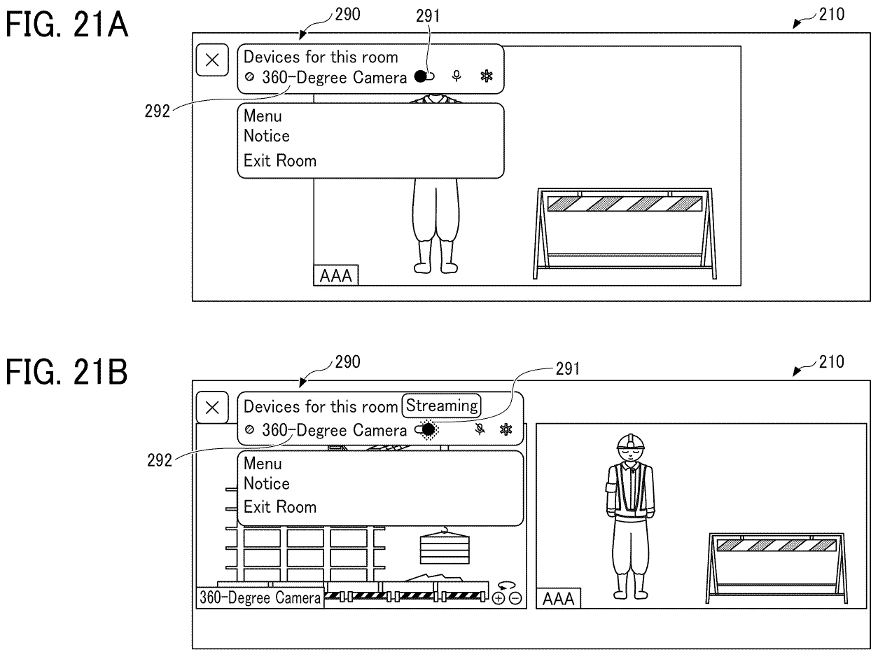

FIG. 20 illustrates an example of a third virtual room association screen 280. The third virtual room association screen 280 includes a name 281 of the image capturing apparatus 10 that is currently (or has already been) associated with the virtual room, a list of devices 282 that can be added, and a “Save” button 283. The user A selects a device to be associated with the virtual room from the list of devices 282 that can be added and then presses the “Save” button 283. As a result, the selected device is associated with the virtual room. That is, the corresponding image capturing apparatus ID is registered in the virtual room information storage unit 5002.

### Wide-View Image Transmission Start Process for Image Capturing Apparatus

In the way described above, a device such as the image capturing apparatus 10 is associated with the virtual room. The user A operates the device to start transmitting an image.

For the VR goggles 89 and the smart glasses 88, the user A operates the device main body to turn on or off the transmission of an image. This is because no application dedicated to the communication system 1 is currently operating on the VR goggles 89 or the smart glasses 88. If an application dedicated to the communication system 1 operates on the VR goggles 89 and the smart glasses 88, the user A can also remotely turn on or off the transmission of an image.

For the image capturing apparatus 10, when the application is enabled, the user A can turn on or off the transmission of the wide-view image from the menu of the application after entering the virtual room.

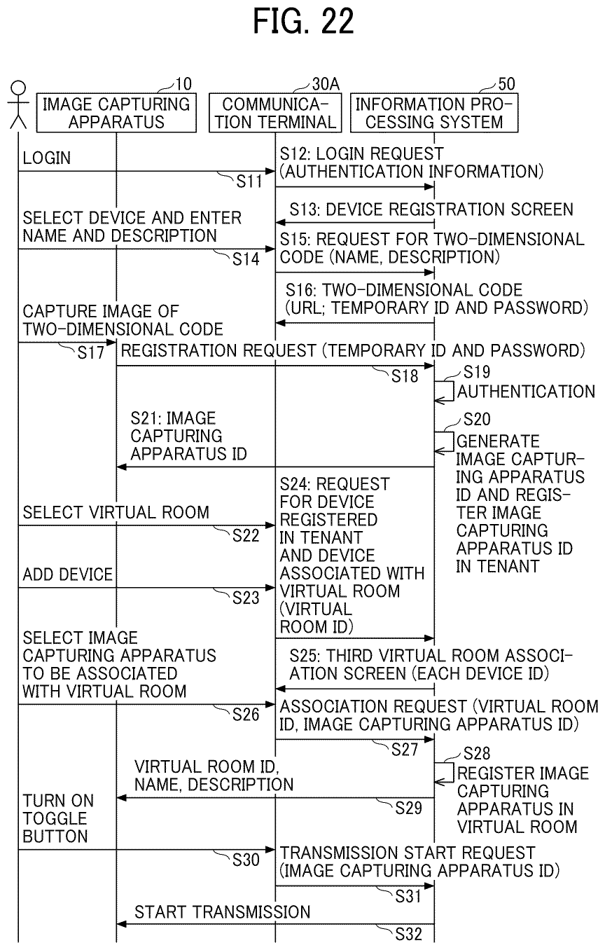

FIGS. 21A and 21B illustrate examples of a wide-view image transmission start/stop dialog 290 displayed on the communication terminal 30A. The wide-view image transmission start/stop dialog 290 is displayed as a pop-up on the image viewing screen 210. In the illustrated example, the user A has operated the communication terminal 30A and entered a virtual room associated with the image capturing apparatus 10. The wide-view image transmission start/stop dialog 290 displays a name 292 of the image capturing apparatus 10 associated with the virtual room. A toggle button 291 is displayed near the name 292. In one example, the user A operates the toggle button 291 to turn on or off the transmission of the wide-view image captured by the image capturing apparatus 10. The setting of on or off using a toggle button is an example. The start or stop of transmission of the wide-view image may be set in accordance with an input of a user operation. In one example, the user may turn on or off the transmission of the wide-view image by selecting a radio button or a predetermined icon or operating the menu. In another example, the transmission of the wide-view image is started automatically, without the user's operation, after the image capturing apparatus 10 enters the room. In another example, a predetermined condition such as the date and time, the number of users who have entered the room, or the participation of a specific user is determined in advance, and the transmission of the wide-view image is started in response to a determination that the predetermined condition is satisfied.

The communication terminal 30A transmits the state of the toggle button 291 to the information processing system 50. The information processing system 50 transmits a transmission start request or a transmission stop request corresponding to the state of the toggle button 291 to the image capturing apparatus 10.

FIG. 21A illustrates an off state of the toggle button 291. In FIG. 21A, thus, the wide-view image is not displayed. By contrast, the image having a normal angle of view captured by the camera 9 of the communication terminal 30A is displayed on the image viewing screen 210 in FIG. 21A since the image having a normal angle of view has already been shared at the time of entry of the communication terminal 30A into the virtual room.

FIG. 21B illustrates an on state of the toggle button 291. In response to turning on of the toggle button 291, the information processing system 50 transmits a transmission start request to the image capturing apparatus 10. Accordingly, the image capturing apparatus 10 starts transmitting the wide-view image. Since two images are shared in one virtual room, the image viewing screen 210 is divided into two areas.

### Procedure for Registering Image Capturing Apparatus in Virtual Room

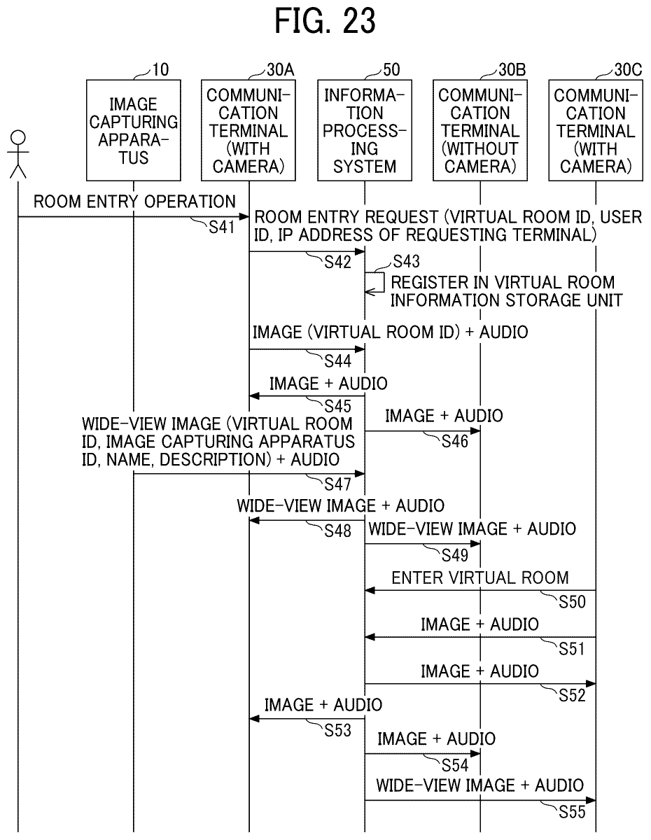

Next, a procedure for registering the image capturing apparatus 10 in the virtual room illustrated in the screen transitions will be described with reference to FIG. 22. FIG. 22 is a sequence diagram illustrating an example of a procedure in which the user A registers the image capturing apparatus 10 in the virtual room.

S11: First, the user A connects the communication terminal 30A to the information processing system 50 and enters authentication information (such as a user ID and a password) to send a login request to log in to the tenant to which the user A belongs. The acceptance unit 32 of the communication terminal 30A accepts the operation.

S12: The communication unit 31 of the communication terminal 30A designates the authentication information and transmits the login request to the information processing system 50. In the information processing system 50, the communication unit 51 receives the login request, and the authentication unit 55 performs authentication. It is assumed that the authentication is successful.

S13: In the information processing system 50, the screen generation unit 52 generates a device registration screen in response to the user operation, and the communication unit 51 transmits screen information of the device registration screen to the communication terminal 30A.

S14: In the communication terminal 30A, the communication unit 31 receives the screen information of the device registration screen, and the display control unit 33 displays the device registration screen. The user A selects the type of the device (in the illustrated example, the image capturing apparatus 10). Then, the user A enters the name and description of the image capturing apparatus 10. The acceptance unit 32 accepts the entered information.

S15: The communication unit 31 of the communication terminal 30A designates the name and description entered by the user A and transmits a request for a two-dimensional code to the information processing system 50.

S16: The communication unit 51 of the information processing system 50 receives the request for a two-dimensional code. The communication group management unit 56 generates a URL (connection destination for registration) in association with the name and the description, and generates a two-dimensional code including the URL, a temporary ID, and a password. The communication unit 51 of the information processing system 50 transmits the two-dimensional code to the communication terminal 30A. In the communication terminal 30A, the communication unit 31 receives the two-dimensional code, and the display control unit 33 displays the two-dimensional code.

S17: The user A operates the image capturing apparatus 10 to be associated with the virtual room to capture an image of the two-dimensional code. The acceptance unit 12 of the image capturing apparatus 10 accepts the operation.

S18: In the image capturing apparatus 10, the imaging processing unit 13 performs an operation of capturing an image including the two-dimensional code to generate image data, and the analysis unit 14 analyzes the image data to extract the URL, the temporary ID, and the password. Accordingly, the registration request unit 15 connects to the URL via the connection unit 16, designates the temporary ID and the password, and transmits a request for registering the image capturing apparatus 10 to the information processing system 50.

S19: In the information processing system 50, the communication unit 51 receives the temporary ID and the password, and the authentication unit 55 determines whether the received temporary ID and password match the temporary ID and password associated with the connected URL. It is assumed that a match is found.

S20: Since a request for registering the image capturing apparatus 10 has been made, the communication group management unit 56 of the information processing system 50 generates an image capturing apparatus ID and registers the image capturing apparatus ID in the tenant to which the user A has logged in. The image capturing apparatus ID is associated with a name and a description.

S21: The communication unit 51 of the information processing system 50 transmits the image capturing apparatus ID to the image capturing apparatus 10. The connection unit 16 of the image capturing apparatus 10 receives the image capturing apparatus ID and stores the image capturing apparatus ID in the storage unit 1000.

S22: The communication terminal 30A is notified of the completion of the registration, and, accordingly, the user A starts associating the image capturing apparatus 10 with the virtual room. The user A selects, from the first virtual room association screen 260 displayed on the communication terminal 30A, a virtual room with which the user A desires to associate the image capturing apparatus 10 registered in the tenant. The acceptance unit 32 of the communication terminal 30A accepts the selection of the virtual room.

S23: The user A displays the second virtual room association screen 270 on the communication terminal 30A and presses an “add device” button. The acceptance unit 32 of the communication terminal 30A accepts the pressing of the “add device” button.

S24: The communication unit 31 of the communication terminal 30A transmits to the information processing system 50 a request for devices registered in the tenant and devices associated with the virtual room ID selected in step S22.

S25: In the information processing system 50, the communication unit 51 receives the request for the devices registered in the tenant and the devices associated with the virtual room ID, and the screen generation unit 52 generates the third virtual room association screen 280 including the device IDs of the devices registered in the tenant and the devices associated with the virtual room ID. The communication unit 51 of the information processing system 50 transmits screen information of the third virtual room association screen 280 to the communication terminal 30A.

S26: In the communication terminal 30A, the communication unit 31 receives the screen information of the third virtual room association screen 280, and the display control unit 33 causes the third virtual room association screen 280 to be displayed. The user A selects the image capturing apparatus 10 to be associated with the virtual room. The acceptance unit 32 of the communication terminal 30A accepts the selection of the image capturing apparatus 10, and the image capturing apparatus ID is identified.

S27: The communication unit 31 of the communication terminal 30A designates the virtual room ID selected in step S22 and the image capturing apparatus ID selected in step S26, and transmits an association request to the information processing system 50.

S28: In the information processing system 50, the communication unit 51 receives the association request, and the communication group management unit 56 registers the image capturing apparatus 10 in the virtual room. That is, the communication group management unit 56 registers the image capturing apparatus ID in the virtual room information storage unit 5002.

S29: Since the image capturing apparatus ID is associated with the virtual room, the communication unit 51 of the information processing system 50 transmits the virtual room ID, the name, and the description to the image capturing apparatus 10. The information processing system 50 may transmit the virtual room ID, the name, and the description to the image capturing apparatus 10 by using a push notification or by using polling, which is performed by the image capturing apparatus 10. The connection unit 16 of the image capturing apparatus 10 receives the virtual room ID, the name, and the description and stores the virtual room ID, the name, and the description in the storage unit 1000. Accordingly, the image capturing apparatus 10 can attach, for example, the image capturing apparatus ID, the virtual room ID, the name, and the description to a wide-view image to be transmitted.

S30: The communication terminal 30A is notified of the completion of the association, and, accordingly, the user A turns on the toggle button 291 for the image capturing apparatus 10 associated with the virtual room on the image viewing screen 210. The acceptance unit 32 of the communication terminal 30A accepts the turn-on operation.

S31: The communication unit 31 of the communication terminal 30A designates the image capturing apparatus ID and transmits, to the information processing system 50, a request for starting transmission of the wide-view image. The user A may directly operate a button of the image capturing apparatus 10 to start transmitting the wide-view image. In response to an operation performed by the user A, the communication unit 31 of the communication terminal 30A may transmit a transmission stop request to the information processing system 50.

S32: The communication unit 51 of the information processing system 50 receives the transmission start request and requests the image capturing apparatus 10 identified by the image capturing apparatus ID to start transmission. The information processing system 50 may use a push notification or use polling, which is performed by the image capturing apparatus 10. In the image capturing apparatus 10, the connection unit 16 receives the transmission start request, and the imaging processing unit 13 starts capturing a wide-view image. The image transmission control unit 18 repeatedly transmits the wide-view image with a determined frame rate (expressed in FPS) or a frame rate (expressed in FPS) corresponding to a bandwidth via the connection unit 16. As a result, the communication terminal 30 that has entered the virtual room can display the state of the site A on the image viewing screen 210 in real time.

### Distribution of Wide-View Image, Image Having Normal Angle of View, and Others

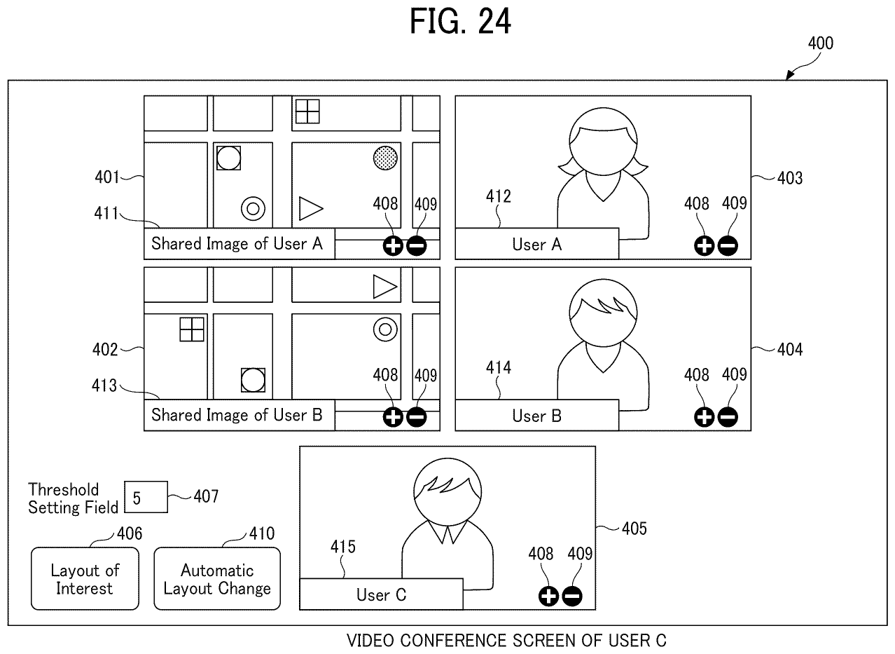

A process for sharing a wide-view image or an image having a normal angle of view will be described with reference to FIG. 23. FIG. 23 is a sequence diagram illustrating an example of a process for sharing a wide-view image. In FIG. 23, the communication terminals 30A and 30B have entered the virtual room. The communication terminal 30A includes the camera 9 having a normal angle of view, and an image captured by the camera 9 is shared with the communication terminal 30B. An image or the like captured by the smart glasses 88 associated with the virtual room, instead of the camera 9 of the communication terminal 30A, may be shared.

S41 to S43: A user enters a virtual room for viewing a wide-view image, as in steps S1 to S5 illustrated in FIG. 17.

S44: In the communication terminal 30A, the imaging unit 34 repeatedly captures an image to obtain captured images, and the communication unit 31 designates the virtual room ID of the virtual room that the communication unit 31 is in and repeatedly transmits the images and audio to the information processing system 50.

S45 and S46: In the information processing system 50, in response to the communication unit 51 receiving the images and the audio, the image distribution unit 54 acquires the IP addresses of the communication terminals 30A and 30B, which are in the virtual room, from the virtual room information storage unit 5002, and transmits the images and the audio via the communication unit 51. In FIG. 23, an image having a normal angle of view is received by the communication unit 31 of the communication terminal 30A from the information processing system 50 and is displayed. In another example, an image having a normal angle of view is not received from the information processing system 50, but an image having a normal angle of view is captured by the imaging unit 34 and is displayed.

S47: In the image capturing apparatus 10, in response to a transmission start request made by turning on the toggle button 291, the imaging processing unit 13 repeatedly captures a wide-view image to obtain captured wide-view images, and the image transmission control unit 18 designates the virtual room ID, the image capturing apparatus ID, the name, and the description and repeatedly transmits the wide-view images and audio to the information processing system 50 via the connection unit 16.

S48 and S49: In the information processing system 50, in response to the communication unit 51 receiving the wide-view images and the audio, the image distribution unit 54 acquires the IP addresses of the communication terminals 30A and 30B, which are in the virtual room, from the virtual room information storage unit 5002, and transmits the wide-view images and the audio via the communication unit 51. The communication unit 51 preferably transmits the image capturing apparatus ID and the name to identify the site from which the wide-view image is obtained.

S50: The communication terminal 30C including the camera 9 newly enters the virtual room.

S51: The communication unit 31 of the communication terminal 30C transmits an image having a normal angle of view and audio to the information processing system 50.

S52 to S54: In the information processing system 50, the communication unit 51 receives the image having a normal angle of view and the audio from the communication terminal 30C, and the image distribution unit 54 acquires the IP addresses of the communication terminals 30A to 30C, which are in the virtual room, from the virtual room information storage unit 5002, and transmits the image having a normal angle of view and the audio.

S55: The communication unit 51 of the information processing system 50 also transmits the wide-view images and the audio to the communication terminal 30C, which is in the same virtual room.

As described above, the users A and B, who are in the same virtual room, can share the wide-view images captured by the image capturing apparatus 10 associated with the virtual room. The order of transmission of the images illustrated in FIG. 23 is an example. In another example, the wide-view images may be shared first, or the images having a normal angle of view may be shared first.

A supplementary description will be given of the smart glasses 88 and the VR goggles 89. The smart glasses 88 have a camera having a normal angle of view and a display function. The camera of the smart glasses 88 captures an image having a normal angle of view, and the captured image having a normal angle of view is distributed in a manner similar to that for the cameras 8 and 9. The display function of the smart glasses 88 is implemented by a flat screen, like that of an ordinary display. Thus, part of a wide-view image is displayed from a point of view designated by the user. The VR goggles 89 have a display function. In one example, the VR goggles 89 may also include a camera having a normal angle of view. The display function of the VR goggles 89 projects a wide-view image with a point of view determined by the orientation of the head of the user wearing the VR goggles 89. Thus, part of the wide-view image is displayed from a point of view corresponding to the orientation of the head of the user.

### Screen Displayed on Communication Terminal and Enlargement Operation

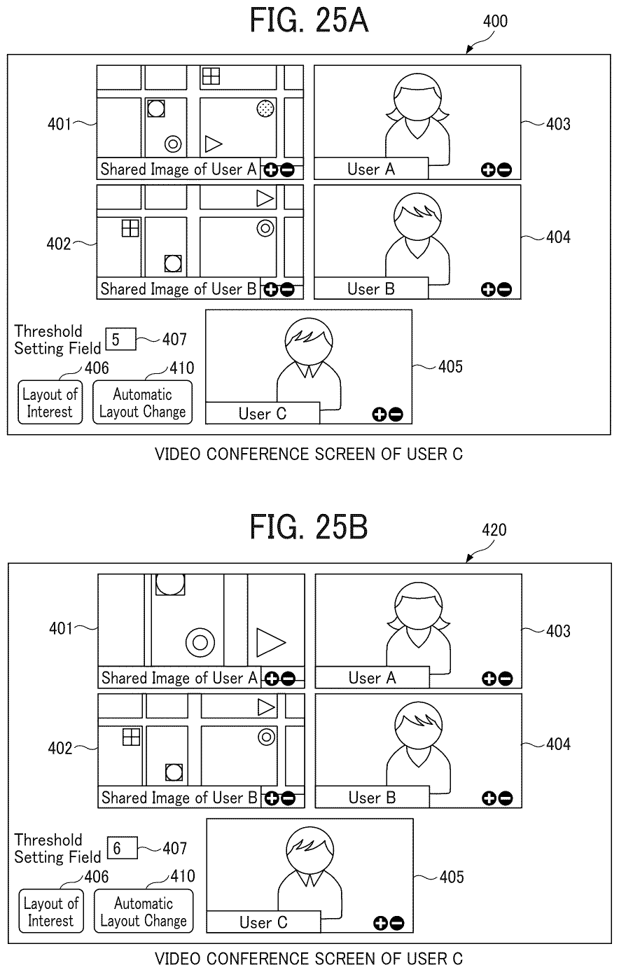

For example, an example of a screen displayed on the communication terminal 30 and an enlargement operation performed on a shared image will be described with reference to, for example, FIG. 24. FIG. 24 illustrates a video conference screen 400 displayed on the communication terminal 30 by a user. For convenience of description, the video conference screen 400 illustrated in FIG. 24 is being displayed on the communication terminal 30C operated by the user C. The following describes the enlargement of a shared image having a normal angle of view, assuming that a wide-view image is not shared or is shared but is not subjected to an enlargement operation.

Three participants (e.g., the users A, B, and C) participate in a conference. The video conference screen 400 includes three face image fields, namely, a face image field 403, a face image field 404, and a face image field 405, to display face images of the users A, B, and C, respectively. Each of the users A and B is sharing a material. The sharing of a material refers to displaying of a material held by a participant on the communication terminals 30 of the participant and the other participants. The video conference screen 400 displays images of materials of the users A and B. The images of the materials are shared images. The video conference screen 400 further includes two shared image fields, namely, a shared image field 401 and a shared image field 402. The shared image field 401 is a field for displaying a shared image transmitted from the communication terminal 30A operated by the user A. The shared image field 402 is a field for displaying a shared image transmitted from the communication terminal 30B operated by the user B. The materials are, for example but are not limited to, maps having large sizes (or areas). In the following description, the shared image transmitted from the communication terminal 30A operated by the user A may be referred to as a “shared image of the user A”, and the shared image transmitted from the communication terminal 30B operated by the user B may be referred to as a “shared image of the user B”.

The shared image fields 401 and 402 and the face image fields 403 to 405 display site names 411, 413, 412, 414, and 415, respectively. Also, the shared image fields 401 and 402 and the face image fields 403 to 405 each display an enlargement button 408 and a reduction button 409. When the user C presses the enlargement button 408 or the reduction button 409, the shared images in the shared image fields 401 and 402 and the face images in the face image fields 403 to 405 can be enlarged or reduced. The video conference screen 400 further includes a layout-of-interest button 406. The layout-of-interest button 406 is a button for displaying a shared image of interest and a region of interest of the shared image of interest on the communication terminal 30C operated by the user C. The term “shared image of interest” refers to a shared image recommended to attract attention due to the high frequency with which the shared image attracts attention from the other users. The term “region of interest” refers to a partial region recommended to attract further attention in a shared image of interest.

The layout-of-interest button 406 may be provided together with an automatic layout change button 410. When the automatic layout change button 410 is selected, the information processing system 50 periodically transmits a shared image of interest and a region of interest to the communication terminals 30 without the user pressing the layout-of-interest button 406 each time.

Alternatively, the layout-of-interest button 406 and the automatic layout change button 410 may be omitted. In a case where the layout-of-interest button 406 and the automatic layout change button 410 are omitted, the communication terminal 30 transmits a request to the information processing system 50 at regular intervals, and the video conference screen on the communication terminal 30 is updated each time the request is transmitted from the communication terminal 30 to the information processing system 50. In another example, the information processing system 50 may periodically update the video conference screen on each communication terminal 30 without a request from the communication terminal 30 to the information processing system 50.

The video conference screen 400 further includes a setting field 407 for setting a threshold for determining a shared image of interest. As described below, the user can adjust the threshold to change the number of shared images of interest to be displayed on the video conference screen 400. The setting field 407 is optional, and the threshold may be determined in advance.

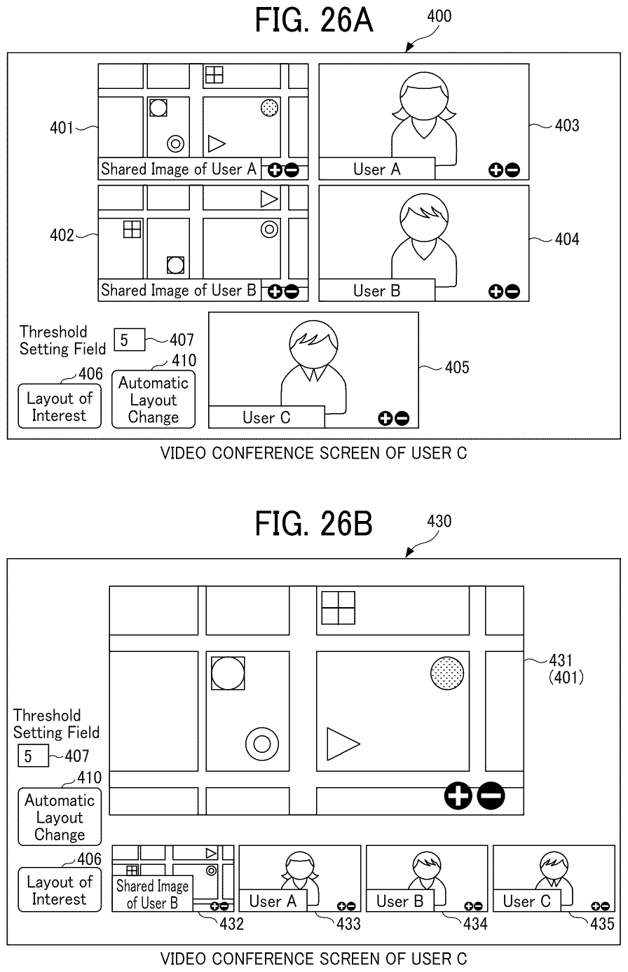

FIGS. 25A and 25B are diagrams illustrating how a shared image changes in response to the user C performing an enlargement operation on a portion of the shared image. FIG. 25A illustrates the video conference screen 400 before the enlargement operation is performed. FIG. 25B illustrates a video conference screen 420 after the enlargement operation is performed. The video conference screen 400 illustrated in FIG. 25A is the same as the video conference screen 400 illustrated in FIG. 24.

In response to the user C pressing the enlargement button 408 in the shared image field 401, the shared image in the shared image field 401 is enlarged. Accordingly, a portion of the shared image of the user A is displayed in an enlarged manner in the shared image field 401 in FIG. 25B. Such enlargement is referred to as “partial enlargement”. The partial enlargement does not increase the size of the shared image field 401. The enlarged shared image is displayed in the shared image field 401 having the same size as that before the enlargement operation. The use case of such an enlargement operation may be, for example, in a scene where a shared image to be enlarged and another shared image or a face image are to attract attention.

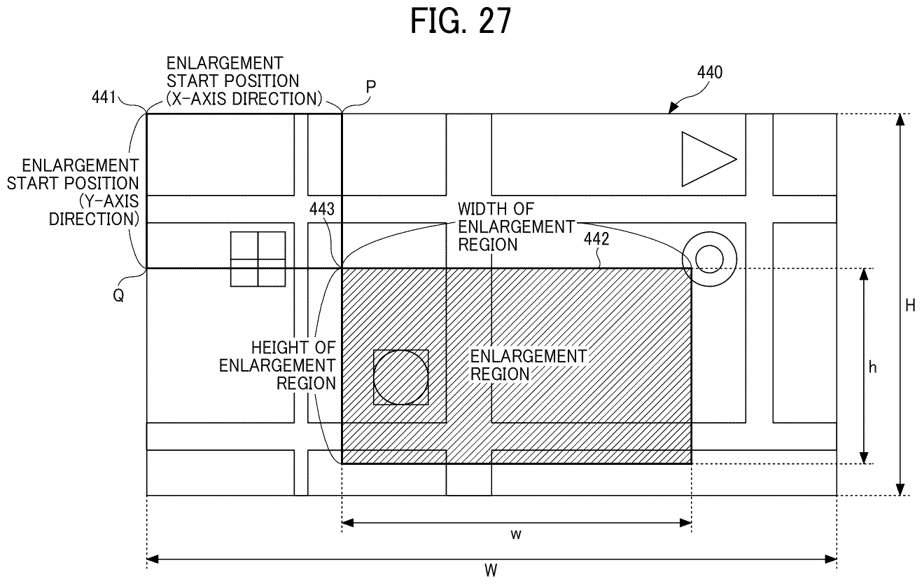

FIGS. 26A and 26B are diagrams illustrating how a layout changes in response to the user C performing an enlargement operation on one shared image field. FIG. 26A illustrates the video conference screen 400 before the enlargement operation is performed. FIG. 26B illustrates a video conference screen 430 after the enlargement operation is performed. The video conference screen 400 illustrated in FIG. 26A is the same as the video conference screen 400 illustrated in FIG. 24.

The user C wishes to display the entire shared image field 401 in a large size. The shared image field 401 is enlarged to obtain a shared image field 431 illustrated in FIG. 26B. In FIG. 26B, unlike FIG. 25B, the shared image field 431 is displayed in a larger size than a shared image field 432 and face image fields 433 to 435. Such enlargement is referred to as “full enlargement”. The partial enlargement may be performed after the full enlargement, or the full enlargement may be performed after the partial enlargement.

The full enlargement may be performed in any way. For example, the user may drag the edge of an image, as in a window operation, to enlarge the image fully. The user may double-click the shared image field 401 to perform the full enlargement. In the case of the full enlargement, as described below, two values indicating “whether enlargement is made” are used to determine a shared image. Thus, no consideration may be given to the ratio of the image size before the enlargement to the image size after the enlargement. Also in the case of the partial enlargement, two values indicating “whether enlargement is made” are used to determine a shared image. In the case of the partial enlargement, however, an enlargement region is used to determine a region of interest.

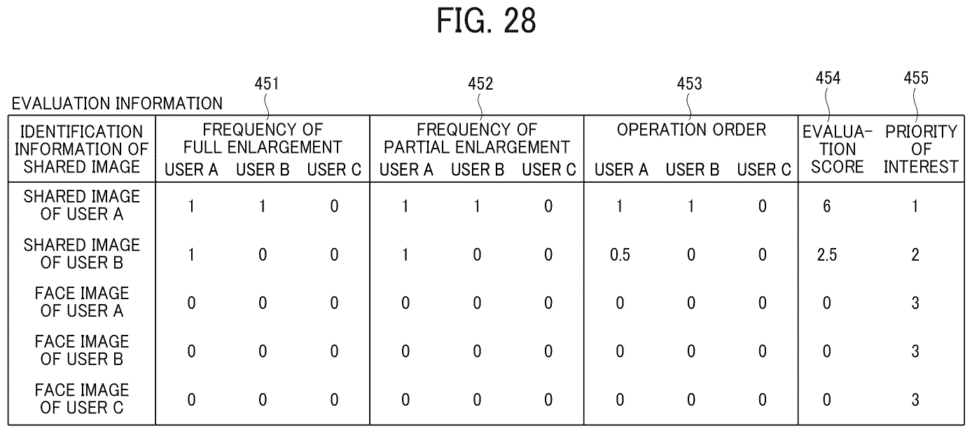

FIG. 27 is a diagram illustrating enlargement operation information for the partial enlargement. In the present embodiment, an enlargement start position 443 may be designated by the user or may be fixed. The position of the enlargement start position 443 in the x-axis direction is specified by a ratio relative to a width W of a shared image field 440, and the position of the enlargement start position 443 in the y-axis direction is specified by a ratio relative to a height H of the shared image field 440. When the shared image field 440 has the width W and the height H, the position of the enlargement start position 443 in the x-axis direction is defined as “a length from an upper left corner 441 of the shared image field 440 to a position P in the x-axis direction/W”, and the position of the enlargement start position 443 in the y-axis direction is defined as “a length from the upper left corner 441 of the shared image field 440 to a position Q in the y-axis direction/H”.

For example, when the enlargement start position 443 is at the center of the shared image field 440, the value of the enlargement start position 443 in the x-axis direction is 0.5, and the value of the enlargement start position 443 in the y-axis direction is 0.5.

An enlargement region 442 has a width w and a height h, which are specified by a ratio relative to the width W of the shared image field 440 and a ratio relative to the height H of the shared image field 440, respectively. When the width w and the height h of the enlargement region 442 are half the width W and the height H of the shared image field 440, respectively, both the width w and the height h of the enlargement region 442 are 0.5.

The enlargement operation information related to the partial enlargement described above is stored in the enlargement operation information storage unit 5004. The evaluation information storage unit 5003 stores information indicating, for example, the presence or absence of the full enlargement and the presence or absence of the partial enlargement.

### Evaluation Information Storage Unit 5003

FIG. 28 is an illustration of evaluation information stored in the evaluation information storage unit 5003. The evaluation information storage unit 5003 (an example of a first memory) stores evaluation information as illustrated in FIG. 28.

Row headings of the evaluation information specify identification information of shared images transmitted from the respective sites. While, in FIG. 28, five communication terminals 30 are participating in the conference, the number of communication terminals 30 is an example. The communication terminals 30 may be considered to be sites.

Column headings of the evaluation information specify, from left to right of columns, the frequency of full enlargement 451 (an example of a second frequency), the frequency of partial enlargement 452 (an example of a first frequency), an operation order 453, an evaluation score 454, and a priority of interest 455. The frequency of full enlargement 451, the frequency of partial enlargement 452, and the operation order 453 are associated with the identification information of a user who has performed an enlargement operation. The identification information of the user may be identification information of the communication terminal 30.

The number of users in the column headings is three because the remaining two users are participating in the conference in viewing mode and are not allowed to perform an enlargement operation or are omitted for convenience of description.

The frequency of full enlargement 451 and the frequency of partial enlargement 452 are set to “1” to indicate that the user has performed an enlargement operation, and are set to “0” to indicate that the user has not performed an enlargement operation. Accordingly, a larger number of “1”'s in the row direction indicates a higher frequency of an enlargement operation on the shared image. Since different locations in the same shared image may be enlarged a large number of times, the frequency of partial enlargement 452 may record the number of operations for the partial enlargement, in addition to the presence or absence of the partial enlargement. The image-of-interest determination unit 62 calculates the evaluation score 454 using the number of operations instead of the frequency of partial enlargement 452.

The operation order 453 records the order in which the users in the column headings performed an enlargement operation on the five shared images after the order is converted into values, for example, “1”, “0.5”, “0.25”, “0.125”, and “0.0625”. A larger value indicates a later position in the order. This configuration makes it more likely that shared images on which an enlargement operation is performed at close times are selected as shared images of interest. The enlargement operation may involve either the full enlargement or the partial enlargement, or both.

The frequency of full enlargement 451, the frequency of partial enlargement 452, the operation order 453, the evaluation score 454, and the priority of interest 455 are desirably initialized each time the material in the shared image field is switched. This is because, when the material changes, the previous frequency related to the material may become less reliable. The switching of the material in the shared image field may be detected using, for example, a page switching button or an equivalent operation signal, or may be detected when a difference obtained by comparing shared images in the shared image field at regular time intervals is greater than or equal to a threshold.

In the column headings, the evaluation score 454 specifies the sum of numerical values in each row. That is, the column representing the evaluation score 454 specifies, for each shared image, the sum of the numerical values of the frequency of full enlargement 451, the frequency of partial enlargement 452, and the operation order 453. In a case where the sum of numerical values in each row is calculated, the number of times an enlargement operation has been performed by all the users may be recorded in each of the frequency of full enlargement 451 and the frequency of partial enlargement 452 without identifying the individual users.

The image-of-interest determination unit 62 may calculate the sum of numerical values in each row by weighting the numerical values. For example, the presence or absence of an enlargement operation by the host of the conference, a qualified participant, or a presenter during speech, or the number of times such an enlargement operation has been performed may be weighted more heavily than the presence or absence of an enlargement operation by the other participants or the number of times an enlargement operation has been performed by the other participants. This configuration facilitates accurate determination of a shared image of interest. Whether the presenter has performed an enlargement operation during speech can be detected by transmitting audio to the information processing system 50 together with the enlargement operation information.

In the column headings, the priority of interest 455 specifies the serial numbers assigned to the respective shared images in descending order of the evaluation score 454.

The evaluation score 454 of each shared image is compared with the threshold set in the setting field 407 illustrated in, for example, FIG. 24. In response to the user pressing the layout-of-interest button 406, the set threshold is transmitted to the information processing system 50. Alternatively, a fixed value may be set as the threshold in advance. When the layout-of-interest button 406 is pressed on any communication terminal 30 (to display a region of interest in a shared image of interest), it is determined that the shared image for which the evaluation score 454 exceeds the threshold is of interest, and the region of interest in the shared image is determined. For example, when the threshold is 5, in FIG. 28, it is determined that only the “shared image of the user A” is of interest, and the shared image transmitted from the communication terminal 30A operated by the user A is a shared image of interest. Further, the region of interest is determined for the shared image transmitted from the communication terminal 30A. The region of interest is determined based on the enlargement operation information storage unit 5004. As described above, for each communication terminal 30 from which a threshold has been transmitted, the evaluation score 454 is compared with the threshold, and thus the number of shared images of interest may differ for each communication terminal 30. In other words, each user can adjust the number of shared images of interest by setting a threshold.

The image-of-interest determination unit 62 may determine one shared image having the highest evaluation score 454 regardless of the threshold.

The evaluation score 454 may be calculated based on one or more of the frequency of full enlargement 451, the frequency of partial enlargement 452, and the operation order 453. The user may select information for determining a shared image of interest from among the frequency of full enlargement 451, the frequency of partial enlargement 452, and the operation order 453.

When a shared image of interest is to be determined using the frequency of partial enlargement 452, a shared image of interest can be determined based on a partial enlargement operation even on a video conference screen whose window size is fixed or unchangeable as desired.

### Enlargement Operation Information Storage Unit 5004

FIG. 29 is an illustration of enlargement operation information stored in the enlargement operation information storage unit 5004. The enlargement operation information storage unit 5004 (an example of a second memory) stores enlargement operation information as illustrated in FIG. 29.

Row headings of the enlargement operation information specify identification information of shared images transmitted from the respective sites. While, in FIG. 29, five communication terminals 30 are participating in the conference, the number of communication terminals 30 is an example. The communication terminals 30 may be considered to be sites.

Column headings of the enlargement operation information specify identification information of the respective communication terminals 30 or the respective users. Information for identifying an enlargement region is recorded for the identification information of each communication terminal 30 or each user. The information for identifying an enlargement region includes an enlargement start position in the x-axis direction, an enlargement start position in the y-axis direction, the width of the enlargement region, and the height of the enlargement region. The details of these parameters have been described with reference to FIG. 27.

In FIG. 29, the enlargement regions of the users A and B in the column headings are the same. In many cases, the enlargement regions of a plurality of users are unlikely to match. The image-of-interest determination unit 62 may determine a region of interest in the following way.

The image-of-interest determination unit 62 determines, as a region of interest, an overlapping region in the enlargement regions of the users. When there is no overlapping region, a region including both the enlargement regions may be determined as a region of interest, or the entire shared image may be determined as a region of interest. Alternatively, the image-of-interest determination unit 62 inputs the enlargement regions of the respective users to a model trained in advance, and the model outputs an optimal region of interest.

The user may perform an enlargement operation on a face image instead of a shared image. That is, any object may appear in an image of interest. In another example, the recording of the presence or absence of an enlargement operation and the enlargement operation information may be restricted depending on the content of image data of a shared image such that the information processing system 50 can determine, as a shared image of interest, a shared image in which an object such as a map appears. In this case, in response to detection of a face image by image processing, the enlargement operation information management unit 61 does not record the presence or absence of an enlargement operation and the enlargement operation information. In contrast, in response to detection that the shared image is a specific image such as a map by image processing, the enlargement operation information management unit 61 may record the presence or absence of an enlargement operation and the enlargement operation information.

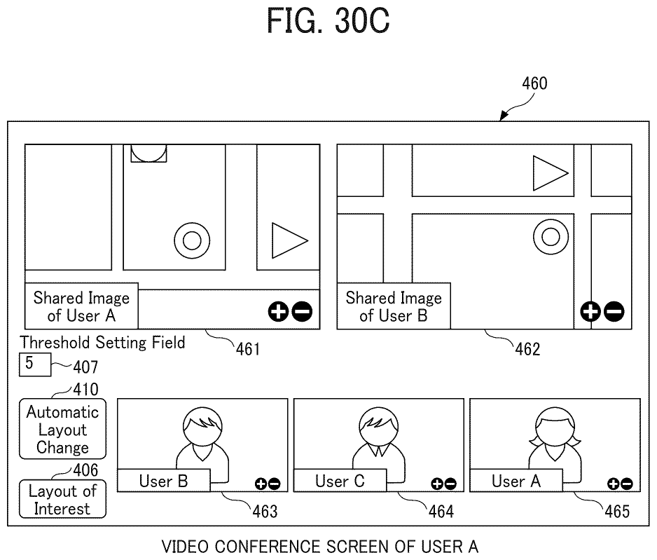

Next, a method for determining a shared image of interest and a region of interest by using evaluation information and enlargement operation information will be described with reference to, for example, FIGS. 30A, 30B, and 30C.

FIGS. 30A to 30C illustrate video conference screens displayed on the communication terminals 30 operated by the users A, B, and C. FIG. 30A illustrates a video conference screen 400 on the communication terminal 30 operated by the user C. FIG. 30B illustrates a video conference screen 430 on the communication terminal 30 operated by the user B. FIG. 30C illustrates a video conference screen 460 on the communication terminal 30 operated by the user A. The video conference screen 400 illustrated in FIG. 30A is the same as the video conference screen 400 illustrated in FIG. 24, and the video conference screen 430 illustrated in FIG. 30B is the same as the video conference screen 430 illustrated in FIG. 26B.

As illustrated in FIG. 30A, the user C has not performed an enlargement operation.

As illustrated in FIG. 30B, the user B has enlarged the entire shared image field 431 (the shared image of the user A) and further enlarged a portion of the shared image field 431.

As illustrated in FIG. 30C, the user A has enlarged the entirety of a shared image field 461 (the shared image of the user A) and further enlarged a portion of the shared image field 461. The user A has enlarged the entirety of a shared image field 462 (the shared image of the user B) and further enlarged a portion of the shared image field 462. FIG. 30C also displays face image fields 463, 464, and 465.

In the states illustrated in FIGS. 30A to 30C, the user C presses the layout-of-interest button 406 on the video conference screen 400. Accordingly, the video conference screen 400 on the communication terminal 30 operated by the user C displays the shared image having the highest evaluation score and a region of interest of the shared image.

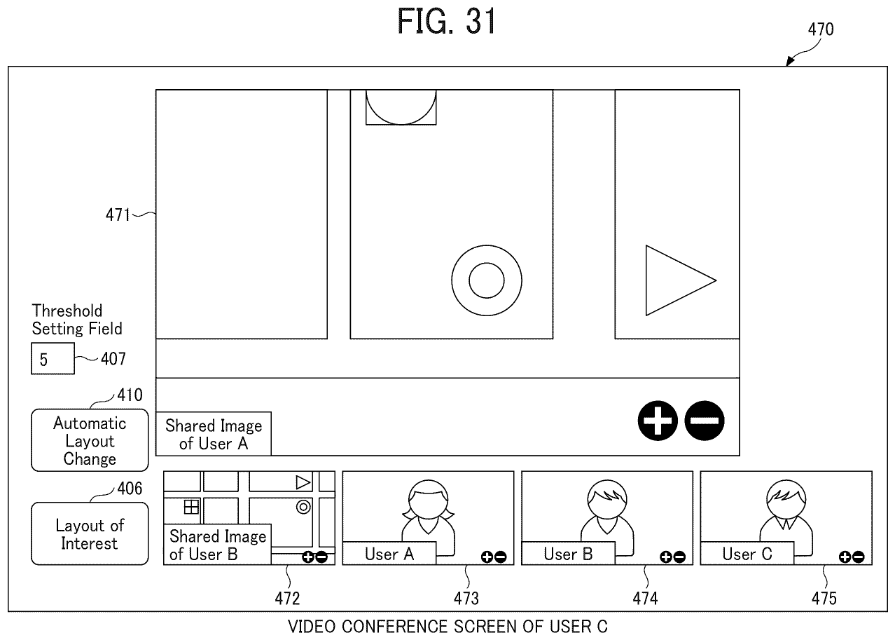

FIG. 31 illustrates a video conference screen 470 displayed on the communication terminal 30C in response to the user C pressing the layout-of-interest button 406. In response to the layout-of-interest button 406 being pressed, the communication terminal 30C operated by the user C requests the information processing system 50 to transmit identification information of a shared image of interest and a region of interest. The image-of-interest determination unit 62 determines identification information of a shared image of interest and a region of interest, and returns the identification information of the shared image of interest and the region of interest to the communication terminal 30C. The display control unit 33 of the communication terminal 30C changes the layout of the video conference screen 470, based on the identification information of the shared image of interest and the region of interest.

The evaluation score 454 illustrated in FIG. 28 indicates that only the “shared image of the user A” is determined to be a shared image of interest. Accordingly, the video conference screen 470 on the communication terminal 30C operated by the user C displays a shared image field 471 for displaying the shared image of the user A in a larger size than the other images, namely, a shared image field 472 (the shared image of the user B) and face image fields 473 to 475. In the shared image field 471, the region of interest of the shared image of the user A is displayed in an enlarged manner. The region of interest is determined based on the enlargement operation information illustrated in FIG. 29. In FIG. 29, the users A and B have the same enlargement region (the enlargement start position in the x-axis direction=0, the enlargement start position in the y-axis direction=0.5, the width of the enlargement region=0.5, and the height of the enlargement region=0.5). Thus, the region of interest is determined based on this enlargement region.

When the threshold is 2 for the evaluation score 454 illustrated in FIG. 28, the “shared image of the user A” and the “shared image of the user B” are determined to be shared images of interest. Accordingly, the video conference screen 470 on the communication terminal 30C operated by the user C displays the shared image fields 471 and 472 for displaying the shared images of the users A and B, respectively, in the same size and in a larger size than the face image fields 473 to 475. In the shared image field 471, the region of interest in the shared image of the user A is displayed in an enlarged manner. In the shared image field 472, the region of interest in the shared image of the user B is displayed in an enlarged manner. The region of interest in the shared image field 471 is the same as that illustrated in FIG. 31. In FIG. 29, the region of interest in the shared image field 472 is enlarged only by the user A (the enlargement start position in the x-axis direction=0.5, the enlargement start position in the y-axis direction=0, the width of the enlargement region=0.5, and the height of the enlargement region=0.5). Thus, the region of interest is determined based on this enlargement region.

As described above, a single communication terminal 30 displays a plurality of shared images, a portion of a large shared image such as a map is enlarged, and it is difficult for the user to determine which shared region is to be focused on. Even in this case, a region of interest in a shared image of interest to the communication terminal 30 can be displayed in an enlarged manner. For example, in a safety patrol of a building including a plurality of floors at a construction site, images of respective floors are displayed on a single communication terminal 30. Also in the case of construction confirmation, images of a plurality of floors or locations are displayed on a single communication terminal 30. As described above, in a situation in which a plurality of similar wide images are shared, even when a user is unsure which region to focus on, a region of interest in a shared image of interest to the communication terminal 30 can be displayed in an enlarged manner.

### Procedure for Displaying Region of Interest

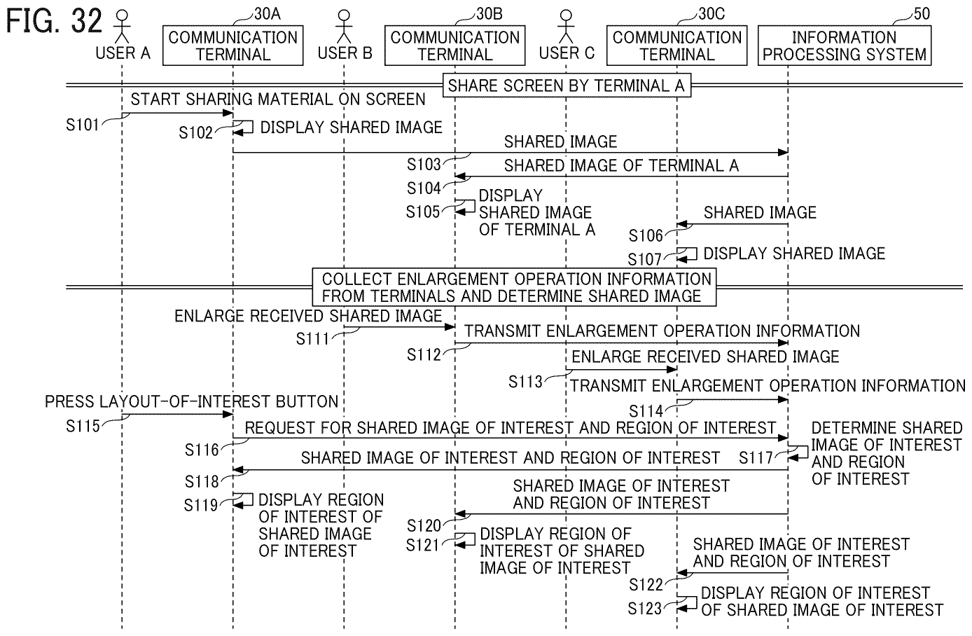

FIG. 32 is a sequence diagram illustrating a process in which the user C displays a region of interest. Two or more of the communication terminals 30A to 30C share a shared image.

S101: The user A participating in the conference inputs an image sharing operation to the communication terminal 30A to share a material held by the user A with another user. The acceptance unit 32 accepts the image sharing operation.

S102: The display control unit 33 of the communication terminal 30A operated by the user A displays a shared image transmitted from the user A.

S103: The communication unit 31 of the communication terminal 30A operated by the user A transmits the shared image and a share start request to the information processing system 50.

S104: The communication unit 51 of the information processing system 50 receives the share start request, and the image distribution unit 54 acquires the IP address of the communication terminal 30B, which is in the same virtual room as the virtual room that the user A is in, from the virtual room information storage unit 5002 and transmits to the communication terminal 30B the shared image transmitted from the user A via the communication unit 51.

S105: The communication unit 31 of the communication terminal 30B receives the shared image, and the display control unit 33 displays the shared image transmitted from the communication terminal 30A operated by the user A.

S106: Also, the image distribution unit 54 acquires the IP address of the communication terminal 30C, which is in the same virtual room as the virtual room that the user A is in, from the virtual room information storage unit 5002 and transmits to the communication terminal 30C the shared image transmitted from the user A via the communication unit 51.

S107: The communication unit 31 of the communication terminal 30C receives the shared image, and the display control unit 33 displays the shared image transmitted from the user A.

The shared image to be shared by the user B is also displayed on the communication terminals 30A to 30C, which are operated by the users A to C, respectively, by similar processing.

Next, a process performed when an enlargement operation is performed on a shared image will be described.

S111: The user B performs an operation on the communication terminal 30B to enlarge the shared image transmitted from the communication terminal 30A of the user A. This operation may be the partial enlargement or the full enlargement. The acceptance unit 32 accepts the operation.

S112: The communication unit 31 of the communication terminal 30B transmits enlargement operation information to the information processing system 50. In the case of the partial enlargement, the enlargement operation information includes identification information of the enlarged shared image and an enlargement region. In the case of the full enlargement, the enlargement operation information includes identification information of the enlarged shared image.

S113 and S114: The user C also performs an enlargement operation.

S115: For example, the user A presses the layout-of-interest button 406. The acceptance unit 32 accepts the pressing of the layout-of-interest button 406.

S116: The communication unit 31 of the communication terminal 30A operated by the user A transmits a request for a shared image of interest and a region of interest to the information processing system 50. For example, the information processing system 50 may periodically determine a shared image of interest and a region of interest without a request.

S117: The communication unit 51 of the information processing system 50 receives the enlargement operation information from the communication terminals 30B and 30C. The enlargement operation information management unit 61 stores enlargement operation information related to the partial enlargement in the enlargement operation information storage unit 5004. The enlargement operation information management unit 61 stores, in the evaluation information storage unit 5003, the frequency of the full enlargement and the frequency of the partial enlargement for each shared image and for each user who has performed the enlargement operation. The enlargement operation information management unit 61 may simply record the number of times the enlargement operation has been performed, regardless of the user who has performed the enlargement operation. Further, the enlargement operation information management unit 61 determines, for each shared image, the order in which the enlargement operation is performed, and sets a higher score for a later position in the order in the operation order 453.

Then, in response to the communication unit 51 receiving a request for a shared image of interest and a region of interest, the image-of-interest determination unit 62 determines a shared image of interest and a region of interest. The method for determining a shared image of interest and a region of interest has been described with reference to FIG. 31.

S118: The communication unit 51 of the information processing system 50 transmits the shared image of interest and the region of interest to the communication terminal 30A. The communication unit 51 may transmit identification information of the shared image of interest and the region of interest to the communication terminal 30A.

S119: The communication unit 31 of the communication terminal 30A receives the shared image of interest and the region of interest, and the display control unit 33 enlarges, on the video conference screen, a shared image field in which the shared image of interest is displayed to a size larger than the other shared image fields and displays the region of interest in the enlarged shared image field.

S120 to S123: For each of the communication terminals 30B and 30C, for example, the automatic layout change button 410 is selected, and a shared image of interest and a region of interest are automatically transmitted to each of the communication terminals 30B and 30C. The display control unit 33 of each of the communication terminals 30B and 30C enlarges, on the video conference screen, a shared image field in which the shared image of interest is displayed to a size larger than the other shared image fields and displays the region of interest in the enlarged shared image field. As described above, at least one communication terminal 30 can display a region of interest in an enlarged shared image field.

### Application Example of Communication System in Telemedicine

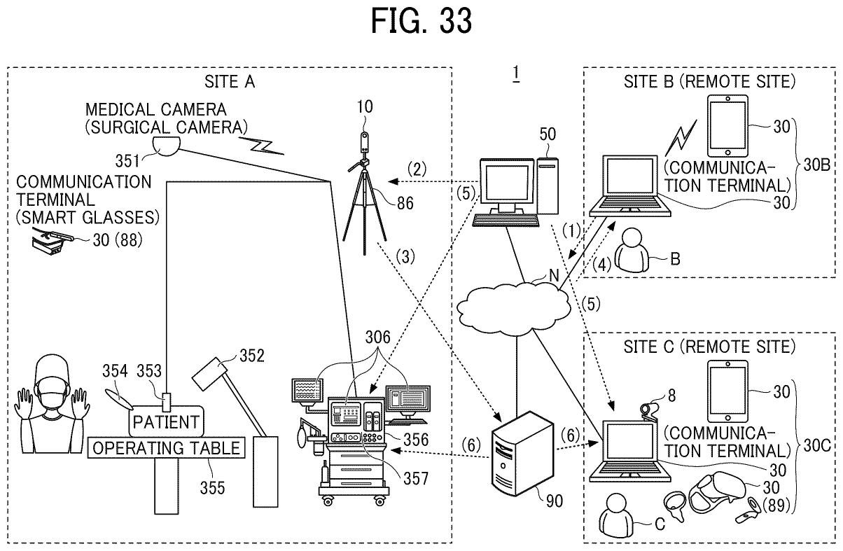

FIG. 33 is a diagram illustrating an example of remote communication using the communication system 1 in telemedicine. In the description of FIG. 33, differences from FIG. 1 will mainly be described. In FIG. 33, the site A is an operating room. The processing steps (1) to (6) in FIG. 33 are similar to those in FIG. 1. In FIG. 33, a patient is placed on an operating table 355 and is subjected to surgery by a medical professional such as a surgeon. The medical professional (corresponding to the user) operates on the patient with various surgical tools 354 such as forceps and a scalpel. The medical professional may wear the smart glasses 88 and transmit an image of the surgical field for surgery performed by the medical professional to the communication network N. Various cameras are placed in the operating room. Examples of the cameras include a surgical camera 351, a surgical field camera 352, and an endoscope 353. All of the cameras in the operating room and the smart glasses 88 are associated with a virtual room.

A main unit 356 is installed in the operating room. The main unit 356 monitors the vitals of a patient, the operating state of medical devices, and the like. The main unit 356 corresponds to the communication terminal 30. The communication terminal 30 (i.e., the main unit 356) in the operating room may have a function of receiving a video from the endoscope 353 or the surgical field camera 352 in addition to the functions illustrated in FIG. 1. In one example, the communication terminal 30 displays the received video on displays 306 and transmits the video to the information processing system 50 as the video of the site at which the communication terminal 30 is located. An operation panel 357 is an input interface that accepts various operations. In one example, a medical professional operates a device in the operating room via the operation panel 357. The endoscope 353, the surgical camera 351, and the surgical field camera 352 may communicate with the information processing system 50 directly without the intervention of the communication terminal 30.

The communication terminal 30 may have the function of an electronic medical record system or the function of communicating with an electronic medical record system. The communication terminal 30 may display information on an electronic medical record on the display 306.

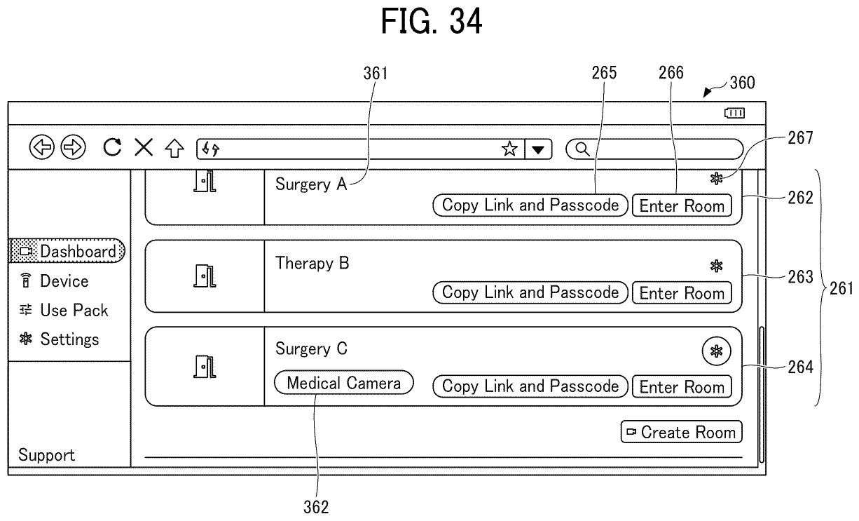

FIG. 34 is a diagram illustrating an example of a first virtual room association screen 360 for associating an image capturing apparatus with a virtual room for telemedicine. In the description of FIG. 34, differences from FIG. 18 will mainly be described.

In telemedicine, in one example, the first virtual room association screen 360 displays a list of virtual rooms 361 associated with remote surgery or medical therapy. One of the virtual rooms 361 is associated with a medical camera 362 including a spherical camera. Examples of the medical camera 362 include an endoscope, a surgical field camera for use in capturing a surgical field image in an operating room, and a camera that captures a microscopic image.

As described above, in a case where shared images of a plurality of sites are shared, the communication system 1 determines a shared image of interest based on an enlargement operation. Thus, each user can view a shared image of interest to participants in a conference. In addition, a region of interest that attracts attention in the shared image is determined based on the enlargement operation. Thus, each user can view a region of interest to the participants in the conference.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

In the example configurations such as that illustrated in FIG. 13, the information processing system 50, the image capturing apparatus 10, and the communication terminal 30 are divided according to main functions thereof to facilitate understanding of the processes performed by the information processing system 50, the image capturing apparatus 10, and the communication terminal 30. No limitation is intended by the divided units of processing or by the name of the units. The processing of each of the information processing system 50, the image capturing apparatus 10, and the communication terminal 30 may be divided into more units of processing in accordance with the content of the processing. Further, the division may be made such that each unit of processing includes more processing operations.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The apparatuses or devices described in one or more embodiments are just one example of plural computing environments that implement the one or more embodiments disclosed herein. In some embodiments, the information processing system 50 includes multiple computing devices such as a server cluster. The multiple computing devices communicate with one another through any type of communication link including a network, a shared memory, or the like and perform the processes disclosed herein.

Further, the information processing system 50 can be configured to share the processing steps disclosed herein, for example, the processing steps illustrated in FIGS. 22, 23, 33, and so on in various combinations. For example, a process executed by a predetermined unit may be executed by multiple information processing apparatuses included in the information processing system 50. The components of the information processing system 50 may be integrated into one server apparatus or divided into multiple apparatuses.

The present disclosure includes the following aspects.

In Aspect 1, a communication system includes a plurality of communication terminals, an information processing system, a first memory, and an image-of-interest determination unit. Each of the plurality of communication terminals displays one or more shared images. The information processing system transmits, via a network, a shared image from one of the plurality of communication terminals to another of the plurality of communication terminals, the shared image being included in the one or more shared images. The first memory stores a first frequency in association with identification information of each of the one or more shared images, the first frequency being a frequency with which a portion of each of the one or more shared images is subjected to an enlargement operation while a size of a display field for displaying a corresponding one of the one or more shared images remains unchanged on each of the plurality of communication terminals. The image-of-interest determination unit determines a shared image of interest among the one or more shared images, based on the first frequency associated with each of the one or more shared images. At least one of the plurality of communication terminals displays the determined shared image of interest in a larger size than a rest of the one or more shared images.

According to Aspect 2, in the communication system of Aspect 1, the first memory further stores a second frequency in association with the identification information of each of the one or more shared images, the second frequency being a frequency with which an overall size of each of the one or more shared images is subjected to an enlargement operation, and the image-of-interest determination unit determines the shared image of interest, based on an evaluation score that evaluates the first frequency and the second frequency for each of the one or more shared images.

According to Aspect 3, in the communication system of Aspect 2, the first memory further stores a value in association with the identification information of each of the one or more shared images, the value indicating a position in an order in which either the enlargement operation on a portion of each of the one or more shared images or the enlargement operation on the overall size of each of the one or more shared images is performed and being obtained by converting the order such that a later position in the order corresponds to a larger value, and the image-of-interest determination unit determines the shared image of interest, based on an evaluation score that evaluates the first frequency, the second frequency, and the value for each of the one or more shared images.

According to Aspect 4, in the communication system of Aspect 2, the first memory stores, in association with the identification information of each of the one or more shared images and identification information of a user who has performed an enlargement operation, presence or absence of the enlargement operation on a portion of each of the one or more shared images and presence or absence of the enlargement operation on the overall size of each of the one or more shared images, the first frequency includes the number of users for whom the presence of the enlargement operation on a portion of each of the one or more shared images is stored, the second frequency includes the number of users for whom the presence of the enlargement operation on the overall size of each of the one or more shared images is stored, and the image-of-interest determination unit determines the shared image of interest, based on an evaluation score that evaluates the first frequency and the second frequency for each of the one or more shared images.

According to Aspect 5, in the communication system of Aspect 4, the first memory stores the number of times the enlargement operation on a portion of each of the one or more shared images is performed, instead of the presence or absence of the enlargement operation on a portion of each of the one or more shared images, the first frequency includes a value obtained by summing the number of times the enlargement operation on a portion of each of the one or more shared images is performed for each user, and the image-of-interest determination unit determines the shared image of interest, based on the value obtained by summing the number of times.

According to Aspect 6, the communication system of any one of Aspects 2 to 5 further includes a second memory. The second memory stores an enlargement region in association with the identification information of each of the one or more shared images and identification information of a user who has performed an enlargement operation on a portion of each of the one or more shared images, the enlargement region being obtained by enlarging a portion of each of the one or more shared images and displaying the enlarged portion. The image-of-interest determination unit determines a region of interest of the shared image of interest determined based on the first frequency, based on all of enlargement regions associated with the identification information of the user, the enlargement regions including the enlargement region. At least one of the plurality of communication terminals displays the determined shared image of interest in a larger size than a rest of the one or more shared images, and displays the region of interest of the shared image of interest in an enlarged manner.

According to Aspect 7, in the communication system of any one of Aspects 2 to 6, the image-of-interest determination unit compares the evaluation score with a threshold and determines, as the shared image of interest, a shared image having the evaluation score greater than the threshold among the one or more shared images.

According to Aspect 8, in the communication system of Aspect 7, each of the plurality of communication terminals displays a setting field for accepting a setting of the threshold, and the image-of-interest determination unit compares, for each of communication terminals from which the threshold for which the setting is accepted is transmitted among the plurality of communication terminals, the evaluation score with the transmitted threshold, and transmits, to each of the communication terminals from which the threshold is transmitted, identification information of the shared image of interest determined for the communication terminal.

1. A communication system comprising:
a plurality of communication terminals each to display a shared image; and
an information processing system to transmit, via a network, the shared image displayed at one of the plurality of communication terminals to another of the plurality of communication terminals, to cause the plurality of communication terminals to each display the shared images,
the information processing system including:
a first memory that stores, for each of the shared images, a first frequency in association with identification information of the shared image, the first frequency indicating a frequency that an enlargement operation is performed on a portion of the shared image while a size of a display field for displaying the shared image remains unchanged on each of the plurality of communication terminals; and
circuitry configured to determine a shared image of interest among the shared images, based on the first frequency associated with each of the shared images,
wherein at least one of the plurality of communication terminals displays the shared image of interest in a larger size than a rest of the shared images.

2. The communication system according to claim 1, wherein
the first memory further stores a second frequency in association with the identification information of each of the shared images, the second frequency indicating a frequency that the enlargement operation is performed on the entire shared image, and
the circuitry is configured to determine the shared image of interest, based on an evaluation score for evaluating the first frequency and the second frequency for each of the shared images.

3. The communication system according to claim 2, wherein
the enlargement operation is performed on the shared images in an order,
the first memory further stores, for each of the shared images, a value in association with the identification information of the shared image, the value indicating a position in the order in which the enlargement operation is performed on either the portion of the shared image or the entire shared image and being obtained by converting the order such that a later position in the order corresponds to a larger value, and
the circuitry is configured to determine the shared image of interest, based on an evaluation score for evaluating the first frequency, the second frequency, and the value for each of the shared images.

4. The communication system according to claim 2, wherein
the first memory stores, for each of the shared images, presence or absence of the enlargement operation on the portion of the shared image and presence or absence of the enlargement operation on the entire shared image, in association with the identification information of the shared image and identification information of a user who has performed the enlargement operation,
the first frequency includes the number of users having the identification information stored in association with the presence of the enlargement operation on the portion of the shared image,
the second frequency includes the number of users having the identification information stored in association with the presence of the enlargement operation on the entire shared image, and
the circuitry is configured to determine the shared image of interest, based on an evaluation score for evaluating the first frequency and the second frequency for each of the shared images.

5. The communication system according to claim 2, wherein
the first memory stores, for each of the shared images, the number of times the enlargement operation is performed on the portion of the shared image, in association with the identification information of the shared image and identification information of a user who has performed the enlargement operation,
the first frequency includes a sum of the number of times the enlargement operation is performed on the portion of the shared image for each user, and
the circuitry is configured to determine the shared image of interest, based on the sum of the number of times.

6. The communication system according to claim 2, further comprising
a second memory that stores, for each of the shared images, an enlargement region in association with the identification information of the shared image and identification information of a user who has performed the enlargement operation on the portion of the shared image, the enlargement region being the portion of the shared image having been enlarged and displayed,
the circuitry is configured to determine a region of interest of the shared image of interest determined based on the first frequency, based on all of the enlargement regions associated with the identification information of the user, and
at least one of the plurality of communication terminals displays the determined shared image of interest in a larger size than a rest of the shared images, and displays the region of interest of the shared image of interest in an enlarged manner.

7. The communication system according to claim 2, wherein
the circuitry is configured to compare the evaluation score with a threshold and determine, as the shared image of interest, a shared image having the evaluation score greater than the threshold among the one or more shared images.

8. The communication system according to claim 7, wherein
each of the plurality of communication terminals displays a setting field for receiving a setting of the threshold, and
the circuitry is configured to:
compare, for each of one or more communication terminals that transmits the threshold for which the setting is received, among the plurality of communication terminals, the evaluation score with the transmitted threshold; and
transmit, to each of the one or more communication terminals that transmits the threshold, identification information of the shared image of interest determined for the communication terminal.

9. An information processing system comprising:
circuitry configured to transmit, via a network, a shared image displayed at one of a plurality of communication terminals to another of the plurality of communication terminals, to cause the plurality of communication terminals to each display the shared images; and
a first memory that stores, for each of the shared images, a first frequency in association with identification information of the shared image, the first frequency indicating a frequency that an enlargement operation is performed on a portion of the shared image while a size of a display field for displaying the shared image remains unchanged on each of the plurality of communication terminals,
wherein the circuitry is configured to:
determine a shared image of interest among the one or more shared images, based on the first frequency associated with each of the shared images; and
transmit the determined shared image of interest to at least one of the plurality of communication terminals, the shared image of interest being displayed in a larger size than a rest of the shared images.

10. An image display method comprising:
transmitting, via a network, a shared image displayed at one of a plurality of communication terminals to another of the plurality of communication terminals to cause the plurality of communication terminals to each display the shared images;
determining a shared image of interest among the shared images, based on a first frequency stored in a first memory in association with each of the shared images,
the first memory storing, for each of the shared images, a first frequency in association with identification information of the shared image, the first frequency indicating a frequency that an enlargement operation is performed on a portion of the shared image while a size of a display field for displaying the shared image remains unchanged on each of the plurality of communication terminals; and
displaying, on at least one of the communication terminals, the determined shared image of interest in a larger size than a rest of the shared images.
